(19) United States
(12) Patent Application Publication
(10) Pub. No.: US 2023/0353466 A1
(43) Pub. Date: Nov. 2, 2023

(54) SYSTEMS AND METHODS FOR ROUTING REMOTE APPLICATION DATA

(71) Applicant: Citrix Systems, Inc., Fort Lauderdale, FL (US)

(72) Inventors: Konstantinos Papanikitas, Patras (GR); Georgios Pispirigkos, Patras (GR); Panagiotis Michalopoulos, Patras (GR)

(21) Appl. No.: 17/836,570

(22) Filed: Jun. 9, 2022

Related U.S. Application Data
(63) Continuation of application No. PCT/GR2022/000024, filed on Apr. 27, 2022.

(51) Int. Cl. H04L 43/06; H04L 43/04; H04L 43/0864

(52) U.S. Cl. CPC H04L 43/06; H04L 43/04; H04L 43/0864

(57) ABSTRACT

Systems and methods for a POP recommendation engine include one or more processors which may identify one or more cloud platforms selected from a plurality of cloud platforms for which to rank one or more points of presence (POP) of a plurality of POPs provided by each of the one or more cloud platforms. The processor(s) may receive metrics on performance of accessing one or more networks by devices via each of the one or more POPs of the plurality of POPs across each of the one or more cloud platforms. The processor(s) may determine a ranking of the plurality of POPs across the one or more cloud platforms based on the metrics. The processor(s) may generate a report identifying the rankings for at least the one or more POPs of the plurality of POPs across the one or more cloud platforms.

### CROSS-REFERENCE TO RELATED APPLICATIONS

This application is a continuation of, and claims priority to and the benefit of International Patent Application No. PCT/GR2022/000024, titled “SYSTEMS AND METHODS FOR ROUTING REMOTE APPLICATION DATA”, and filed on Apr. 27, 2022, the entire contents of which are hereby incorporated herein by references in its entirety for all purposes.

### FIELD OF THE DISCLOSURE

The present application generally relates to computers and networking systems. In particular, the present application relates to systems and methods for improved routing data to and from remote applications.

### BACKGROUND

A network administrator may deploy an application across multiple datacenters, with the intent of identifying the optimal data center from which to deliver the application to a device of an end user.

### BRIEF SUMMARY

One of the primary challenges that is faced by application managers deploying an application which is accessibly by client devices across a variety of geographic locations over a network is selecting which point of presence (POP) or combination of POPs to use to deploy the application. There are several factors that may be considered when selecting which POP or combination of POPs to use when deploying the application. These factors may include the cost of using a particular POP or combination of POPs, the privacy and network security of using a particular POP or combination of POPs, and which POP or combination of POPs may have the best performance. However, which POP or combination of POPs has the best performance may be difficult to determine, because it may not be clear what exactly constitutes a “best performing POP or combination of POPs.”

According to the systems and methods of the present solution, a POP recommendation engine leverages the Real User Measurements (RUMs) collected by users from all over the world and user traffic distributions, to provide recommendations about the best performing POPs or combination of POPs based on the RUMs and user traffic distributions. RUMs refer to real time metrics collected from user browsers or native apps towards a huge list of endpoints including various different cloud platforms and content delivery networks (CDNs). These metrics are collected and aggregated to create performance scores (availability, latency and throughput) from various geographic regions (e.g., continent, country, region, state, locality, etc.) and networks towards a list of cloud POPs and CDNs. The POP recommendation engine takes advantage of the rich data set of RUMs and user traffic distributions to provide the best combination of POPs either per cloud platform vendor or by combining several different cloud platform vendors. The POP recommendation engine may then generate a recommendation list that includes the best performing POP, pair of POPs or combination of three POPs, rankings of the various POPs, and so forth.

At least one aspect of this disclosure is directed to a method. The method includes identifying, by one or more processors, one or more cloud platforms selected from a plurality of cloud platforms for which to rank one or more points of presence (POP) of a plurality of POPs provided by each of the one or more cloud platforms. The method includes receiving, by the one or more processors, metrics on performance of accessing one or more networks by devices via each of the one or more POPs of the plurality of POPs across each of the one or more cloud platforms. The method includes determining, by the one or more processors, a ranking of the plurality of POPs across the one or more cloud platforms based on the metrics. The method includes generating, by the one or more processors, a report identifying the rankings for at least the one or more POPs of the plurality of POPs across the one or more cloud platforms.

In some embodiments, the method further includes receiving, by the one or more processors, from a computing device, a request for the report, the request including the selection of the one or more cloud platforms from the plurality of cloud platform and transmitting, by the one or more processors, the report to the computing device. In some embodiments, the request is received at a time instance and wherein the rankings are determined based on metrics obtained within a duration from the time instance. In some embodiments, the request identifies one or more geographic regions based on which the report is to be generated. In some embodiments, the one or more geographic regions correspond to locations in which devices are to access a resource via a respective POP of the plurality of POPs. In some embodiments, generating the report includes generating, by the one or more processors, the report for a resource accessible via the one or more networks through at least some of the plurality of POPs and transmitting, by the one or more processors, the report to a computing device corresponding to the resource.

In some embodiments, the metrics comprise at least one of a median round trip time (RTT), a median throughput, or an average availability for the respective POPs of the plurality of POPs. In some embodiments, the method further includes computing a score indicating performance of the respective POPs of the plurality of POPs, wherein the score is computed based on a weighted average round trip time (RTT) for the respective POP with respect to at least one of a lowest RTT of the plurality of POPs, an RTT for a geographically closest POP, or the median RTT of the plurality of POPs. In some embodiments, the selection of the one or more cloud platforms from the plurality of cloud platforms comprises a selection of each of the plurality of cloud platforms, and wherein the report includes rankings for at least some of the plurality of POPs of the plurality of cloud platforms.

Another aspect of this disclosure is directed to a system. The system includes one or more processors. The one or more processors are configured to identify one or more cloud platforms selected from a plurality of cloud platforms for which to rank one or more points of presence (POP) of a plurality of POPs provided by each of the one or more cloud platforms. The one or more processors are configured to receive metrics on performance of accessing one or more networks by devices via each of the one or more POPs of the plurality of POPs across each of the one or more cloud platforms. The one or more processors are configured to determine a ranking of the plurality of POPs across the one or more cloud platforms based on the metrics. The one or more processors are configured to generate a report identifying the rankings for at least the one or more POPs of the plurality of POPs across the one or more cloud platforms.

In some embodiments, the one or more processors are further configured to receive, from a computing device, a request for the report, the request including the selection of the one or more cloud platforms from the plurality of cloud platforms and transmit the report to the computing device. In some embodiments, the request is received at a time instance and wherein the rankings are determined based on metrics obtained within a duration from the time instance. In some embodiments, the request identifies one or more geographic regions based on which the report is to be generated. In some embodiments, the one or more geographic regions correspond to locations in which devices are to access a resource via a respective POP of the plurality of POPs.

In some embodiments, the one or more processors are further configured to generate the report for a resource via the one or more networks through at least some of the plurality of POPs and transmit the report to a computing device corresponding to the resource. In some embodiments, the metrics comprise at least one of a median round trip time (RTT), a median throughput, or an average availability for the respective POPs of the plurality of POPs. In some embodiments, the one or more processors are further configured to compute a score indicating performance of the respective POPs of the plurality of POPs, wherein the score is computed based on a weighted average round trip time (RTT) for the respective POP with respect to at least one of a lowest RTT of the plurality of POPs, an RTT for a geographically closest POP, or the median RTT of the plurality of POPs. In some embodiments, the selection of the one or more cloud platforms from the plurality of cloud platforms comprises a selection of each of the plurality of cloud platforms, and wherein the report includes rankings for at least some of the plurality of POPs of the plurality of cloud platforms.

Yet another aspect of this disclosure is directed to a non-transitory computer-readable medium storing instructions that, when executed by one or more processors, cause the one or more processors to identify one or more cloud platforms selected from a plurality of cloud platforms for which to rank one or more points of presence (POP) of a plurality of POPs provided by each of the one or more cloud platforms. The computer-readable medium further stores instructions that cause the one or more processors to receive metrics on performance of accessing one or more networks by devices via each of the one or more POPs of the plurality of POPs across each of the one or more cloud platforms. The computer-readable medium further stores instructions that cause the one or more processors to determine a ranking of the plurality of POPs across the one or more cloud platforms based on the metrics. The computer-readable medium further stores instructions that cause the one or more processors to generate a report identifying the rankings for at least the one or more POPs of the plurality of POPs across the one or more cloud platforms.

In some embodiments, the metrics comprise at least one of a median round trip time (RTT), a median throughput, or an average availability for the respective POPs of the plurality of POPs, and wherein the instructions further cause the one or more processors to compute a score indicating performance of the respective POPs of the plurality of POPs, wherein the score is computed based on a weighted average round trip time (RTT) for the respective POP with respect to at least one of a lowest RTT of the plurality of POPs, an RTT for a geographically closest POP, or the median RTT of the plurality of POPs.

### BRIEF DESCRIPTION OF THE FIGURES

The foregoing and other objects, aspects, features, and advantages of the present solution will become more apparent and better understood by referring to the following description taken in conjunction with the accompanying drawings, in which:

FIG. 1A is a block diagram of embodiments of a computing device;

FIG. 1B is a block diagram depicting a computing environment comprising a client device in communication with cloud service providers;

FIG. 2A is a block diagram of an example system in which resource management services may manage and streamline access by clients to resource feeds (via one or more gateway services) and/or software-as-a-service (SaaS) applications;

FIG. 2B is a block diagram showing an example implementation of the system shown in FIG. 2A in which various resource management services as well as a gateway service are located within a cloud computing environment;

FIG. 2C is a block diagram similar to that shown in FIG. 2B but in which the available resources are represented by a single box labeled “systems of record,” and further in which several different services are included among the resource management services;

FIG. 3 is a diagram of the locations of one or more points of presence (POP) in accordance with an illustrative embodiment;

FIG. 4 is a block diagram of a POP recommendation system in accordance with an illustrative embodiment;

FIG. 5 is a diagram of a user interface for displaying the results of the POP recommendation system of FIG. 4 in accordance with an illustrative embodiment;

FIG. 6 is another diagram of a user interface for displaying the results of the POP recommendation system of FIG. 4 in accordance with an illustrative embodiment;

FIG. 7 is a sequential diagram of a flow of data within the POP recommendation system of FIG. 4 in accordance with an illustrative embodiment;

FIG. 8 is a diagram of a method for generating a POP recommendation in accordance with an illustrative embodiment;

FIG. 9 is a diagram of a method for generating a report that ranks one or more POPs in accordance with an illustrative embodiment;

The features and advantages of the present solution will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

One of the primary challenges that is faced by application managers deploying an application which is accessibly by client devices across a variety of geographic locations over a network is selecting which point of presence (POP) or combination of POPs to use to deploy the application. There are several factors that may be considered when selecting which POP or combination of POPs to use when deploying the application. These factors may include the cost of using a particular POP or combination of POPs, the privacy and network security of using a particular POP or combination of POPs, and which POP or combination of POPs may have the best performance. However, which POP or combination of POPs has the best performance may be difficult to determine, because it may not be clear what exactly constitutes a “best performing POP or combination of POPs.”

According to the systems and methods of the present solution, a POP recommendation engine leverages the RUMs collected by users from all over the world, to provide recommendations about the best performing POPs or combination of POPs based on the RUMs and user traffic distributions. RUMs refer to real time metrics collected from user browsers or native apps towards a huge list of endpoints including various different cloud platforms and content delivery networks (CDNs). These metrics are collected and aggregated to create performance scores (availability, latency and throughput) from various geographic regions (e.g., continent, country, region, state, locality, etc.) and networks towards a list of cloud POPs and CDNs. The POP recommendation engine takes advantage of the rich data set of RUMs to provide the best combination of POPs either per cloud platform vendor or by combining several different cloud platform vendors. The POP recommendation engine may then generate a recommendation list that includes the best performing POP, pair of POPs or combination of three POPs, rankings of the various POPs, and so forth.

For purposes of reading the description of the various embodiments below, the following descriptions of the sections of the specification and their respective contents may be helpful:
Section A describes a computing environment which may be useful for practicing embodiments described herein;
Section B describes resource management services for managing and streamlining access by clients to resource feeds;
Section C describes POP network architecture;
Section D describes systems and methods for generation POP recommendations; and
Section E describes various example embodiments of the systems and methods described herein.

### A. Computing Environment

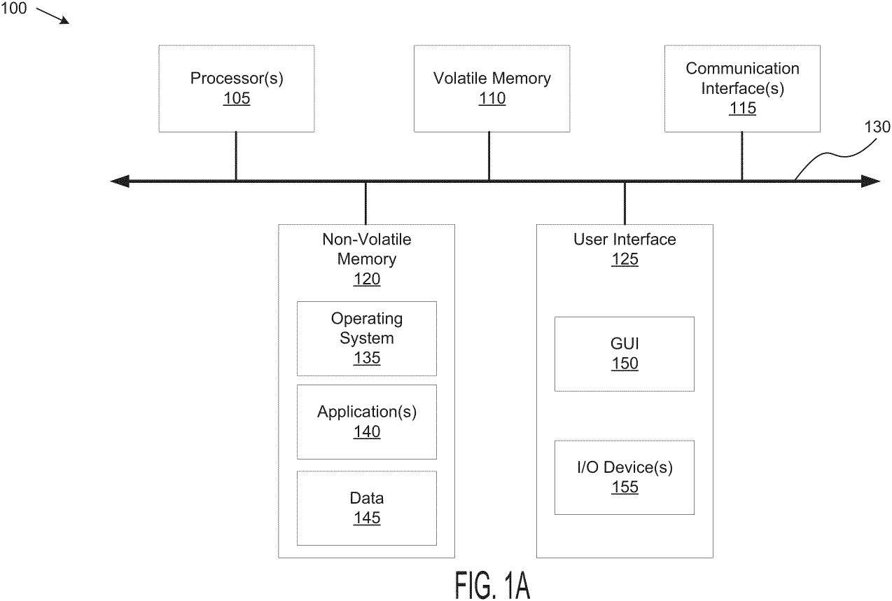

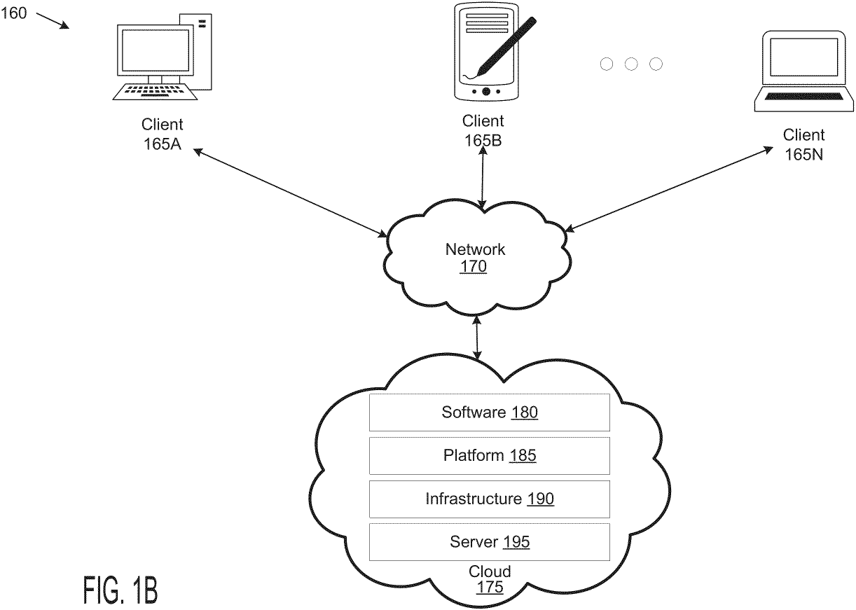

As shown in FIG. 1A, computer 100 may include one or more processors 105, volatile memory 110 (e.g., random access memory (RAM)), non-volatile memory 120 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), user interface (UI) 125, one or more communications interfaces 115, and communication bus 130. User interface 125 may include graphical user interface (GUI) 150 (e.g., a touchscreen, a display, etc.) and one or more input/output (I/O) devices 155 (e.g., a mouse, a keyboard, a microphone, one or more speakers, one or more cameras, one or more biometric scanners, one or more environmental sensors, one or more accelerometers, etc.). Non-volatile memory 120 stores operating system 135, one or more applications 140, and data 145 such that, for example, computer instructions of operating system 135 and/or applications 140 are executed by processor(s) 105 out of volatile memory 110. In some embodiments, volatile memory 110 may include one or more types of RAM and/or a cache memory that may offer a faster response time than a main memory. Data may be entered using an input device of GUI 150 or received from I/O device(s) 155. Various elements of computer 100 may communicate via one or more communication buses, shown as communication bus 130.

Computer 100 as shown in FIG. 1A is shown merely as an example, as clients, servers, intermediary and other networking devices and may be implemented by any computing or processing environment and with any type of machine or set of machines that may have suitable hardware and/or software capable of operating as described herein. Processor(s) 105 may be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations may be hard coded into the circuitry or soft coded by way of instructions held in a memory device and executed by the circuitry. A “processor” may perform the function, operation, or sequence of operations using digital values and/or using analog signals. In some embodiments, the “processor” can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multi-core processors, or general-purpose computers with associated memory. The “processor” may be analog, digital or mixed-signal. In some embodiments, the “processor” may be one or more physical processors or one or more “virtual” (e.g., remotely located or “cloud”) processors. A processor including multiple processor cores and/or multiple processors multiple processors may provide functionality for parallel, simultaneous execution of instructions or for parallel, simultaneous execution of one instruction on more than one piece of data.

Communications interfaces 115 may include one or more interfaces to enable computer 100 to access a computer network such as a Local Area Network (LAN), a Wide Area Network (WAN), a Personal Area Network (PAN), or the Internet through a variety of wired and/or wireless or cellular connections.

In described embodiments, the computer 100 may execute an application on behalf of a user of a client computing device. For example, the computer 100 may execute a virtual machine, which provides an execution session within which applications execute on behalf of a user or a client computing device, such as a hosted desktop session. The computer 100 may also execute a terminal services session to provide a hosted desktop environment. The computer 100 may provide access to a computing environment including one or more of: one or more applications, one or more desktop applications, and one or more desktop sessions in which one or more applications may execute.

Referring to FIG. 1B, a computing environment 160 is depicted. Computing environment 160 may generally be considered implemented as a cloud computing environment, an on-premises (“on-prem”) computing environment, or a hybrid computing environment including one or more on-prem computing environments and one or more cloud computing environments. When implemented as a cloud computing environment, also referred as a cloud environment, cloud computing or cloud network, computing environment 160 can provide the delivery of shared services (e.g., computer services) and shared resources (e.g., computer resources) to multiple users. For example, the computing environment 160 can include an environment or system for providing or delivering access to a plurality of shared services and resources to a plurality of users through the internet. The shared resources and services can include, but not limited to, networks, network bandwidth, servers 195, processing, memory, storage, applications, virtual machines, databases, software, hardware, analytics, and intelligence.

In embodiments, the computing environment 160 may provide client 165 with one or more resources provided by a network environment. The computing environment 160 may include one or more clients 165a-165n, in communication with a cloud 175 over one or more networks 170A, 170B. Clients 165 may include, e.g., thick clients, thin clients, and zero clients. The cloud 175 may include back end platforms, e.g., servers 195, storage, server farms, or data centers. The clients 165 can be the same as or substantially similar to computer 100 of FIG. 1A.

The users or clients 165 can correspond to a single organization or multiple organizations. For example, the computing environment 160 can include a private cloud serving a single organization (e.g., enterprise cloud). The computing environment 160 can include a community cloud or public cloud serving multiple organizations. In embodiments, the computing environment 160 can include a hybrid cloud that is a combination of a public cloud and a private cloud. For example, the cloud 175 may be public, private, or hybrid. Public clouds 175 may include public servers 195 that are maintained by third parties to the clients 165 or the owners of the clients 165. The servers 195 may be located off-site in remote geographical locations as disclosed above or otherwise. Public clouds 175 may be connected to the servers 195 over a public network 170. Private clouds 175 may include private servers 195 that are physically maintained by clients 165 or owners of clients 165. Private clouds 175 may be connected to the servers 195 over a private network 170. Hybrid clouds 175 may include both the private and public networks 170A, 170B and servers 195.

The cloud 175 may include back end platforms, e.g., servers 195, storage, server farms or data centers. For example, the cloud 175 can include or correspond to a server 195 or system remote from one or more clients 165 to provide third party control over a pool of shared services and resources. The computing environment 160 can provide resource pooling to serve multiple users via clients 165 through a multi-tenant environment or multi-tenant model with different physical and virtual resources dynamically assigned and reassigned responsive to different demands within the respective environment. The multi-tenant environment can include a system or architecture that can provide a single instance of software, an application or a software application to serve multiple users. In embodiments, the computing environment 160 can provide on-demand self-service to unilaterally provision computing capabilities (e.g., server time, network storage) across a network for multiple clients 165. The computing environment 160 can provide an elasticity to dynamically scale out or scale in responsive to different demands from one or more clients 165. In some embodiments, the computing environment 160 can include or provide monitoring services to monitor, control and/or generate reports corresponding to the provided shared services and resources.

In some embodiments, the computing environment 160 can include and provide different types of cloud computing services. For example, the computing environment 160 can include Infrastructure as a service (IaaS). The computing environment 160 can include Platform as a service (PaaS). The computing environment 160 can include server-less computing. The computing environment 160 can include Software as a service (SaaS). For example, the cloud 175 may also include a cloud based delivery, e.g. Software as a Service (SaaS) 180, Platform as a Service (PaaS) 185, and Infrastructure as a Service (IaaS) 190. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Washington, RACKSPACE CLOUD provided by Rackspace US, Inc., of San Antonio, Texas, Google Compute Engine provided by Google Inc. of Mountain View, California, or RIGHTSCALE provided by RightScale, Inc., of Santa Barbara, California. PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Washington, Google App Engine provided by Google Inc., and HEROKU provided by Heroku, Inc. of San Francisco, California. SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, California, or OFFICE 365 provided by Microsoft Corporation. Examples of SaaS may also include data storage providers, e.g. DROPBOX provided by Dropbox, Inc. of San Francisco, California, Microsoft SKYDRIVE provided by Microsoft Corporation, Google Drive provided by Google Inc., or Apple ICLOUD provided by Apple Inc. of Cupertino, California.

Clients 165 may access IaaS resources with one or more IaaS standards, including, e.g., Amazon Elastic Compute Cloud (EC2), Open Cloud Computing Interface (OCCI), Cloud Infrastructure Management Interface (CIMI), or OpenStack standards. Some IaaS standards may allow clients access to resources over HTTP, and may use Representational State Transfer (REST) protocol or Simple Object Access Protocol (SOAP). Clients 165 may access PaaS resources with different PaaS interfaces. Some PaaS interfaces use HTTP packages, standard Java APIs, JavaMail API, Java Data Objects (JDO), Java Persistence API (JPA), Python APIs, web integration APIs for different programming languages including, e.g., Rack for Ruby, WSGI for Python, or PSGI for Perl, or other APIs that may be built on REST, HTTP, XML, or other protocols. Clients 165 may access SaaS resources through the use of web-based user interfaces, provided by a web browser (e.g. GOOGLE CHROME, Microsoft INTERNET EXPLORER, or Mozilla Firefox provided by Mozilla Foundation of Mountain View, California). Clients 165 may also access SaaS resources through smartphone or tablet applications, including, e.g., Salesforce Sales Cloud, or Google Drive app. Clients 165 may also access SaaS resources through the client operating system, including, e.g., Windows file system for DROPBOX.

In some embodiments, access to IaaS, PaaS, or SaaS resources may be authenticated. For example, a server or authentication server may authenticate a user via security certificates, HTTPS, or API keys. API keys may include various encryption standards such as, e.g., Advanced Encryption Standard (AES). Data resources may be sent over Transport Layer Security (TLS) or Secure Sockets Layer (SSL).

### B. Resource Management Services for Managing and Streamlining Access by Clients to Resource Feeds

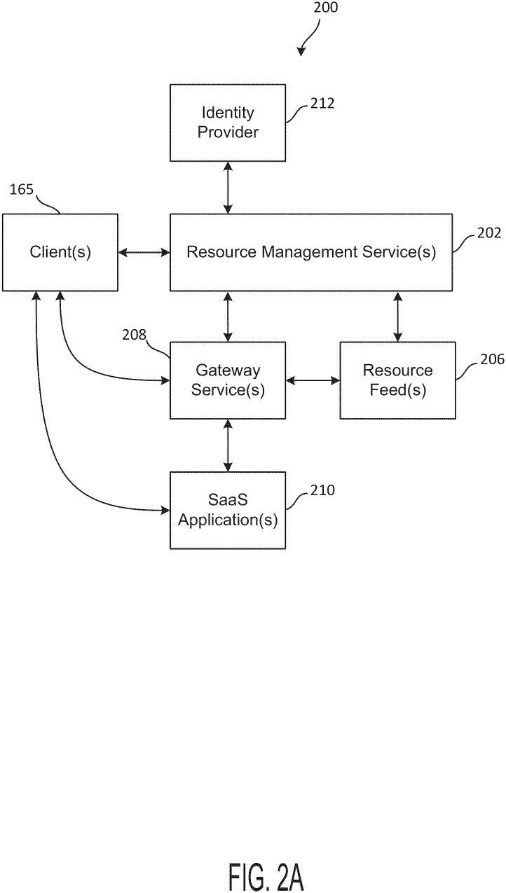

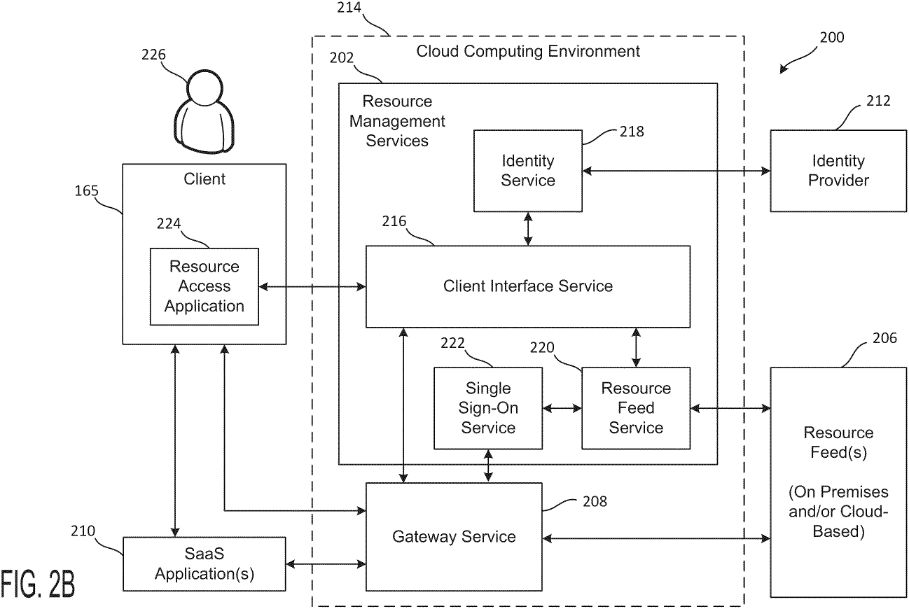

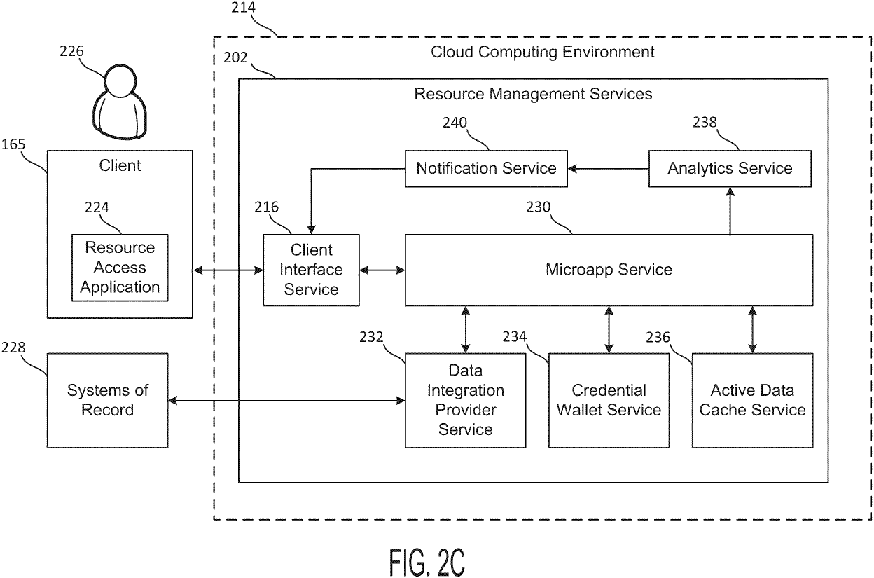

FIG. 2A is a block diagram of an example system 200 in which one or more resource management services 202 may manage and streamline access by one or more clients 165 to one or more resource feeds 206 (via one or more gateway services 208) and/or one or more SaaS applications 210. In particular, the resource management service(s) 202 may employ an identity provider 212 to authenticate the identity of either end-users, which use a client 165, or the appliances themselves. Following authentication, the resource management service(s) 202 can identify one of more resources for which the user has authorization to access. For example, the resource management service(s) can identify that client 165A has authorization to access the resource feed related to DNS multipath routing whereas client 165B is not (e.g., client 165B is not licensed for a feature; client 165B is not multipath capable, etc.). In response to the user selecting one of the identified resources, the resource management service(s) 202 may send appropriate access credentials to the requesting client 165, and the client 165 may then use those credentials to access the selected resource. For the resource feed(s) 206, the client 165 may use the supplied credentials to access the selected resource via a gateway service 208. For the SaaS application(s) 210, the client 165 may use the credentials to access the selected application directly.

The client(s) 165 may be any type of computing devices capable of accessing the resource feed(s) 206 and/or the SaaS application(s) 210, and may, for example, include a variety of desktop or laptop computers, smartphones, tablets, and network appliances such as routers and firewalls. The resource feed(s) 206 may include any of numerous resource types and may be provided from any of numerous locations. In some embodiments, for example, the resource feed(s) 206 may include one or more systems or services for providing virtual applications and/or desktops to the client(s) 165, one or more file repositories and/or file sharing systems, one or more secure browser services, one or more access control services for the SaaS applications 210, one or more management services for local applications on the client(s) 165, one or more internet enabled devices or sensors, etc. Each of the resource management service(s) 202, the resource feed(s) 206, the gateway service(s) 208, the SaaS application(s) 210, and the identity provider 212 may be located within an on-premises data center of an organization for which the system 200 is deployed, within one or more cloud computing environments, or elsewhere.

FIG. 2B is a block diagram showing an example implementation of the system 200 shown in FIG. 2A in which various resource management services 202 as well as a gateway service 208 are located within a cloud computing environment 214. The cloud-computing environment may, for example, include MICROSOFT AZURE Cloud, AMAZON Web Services, GOOGLE Cloud, or IBM Cloud.

For any of illustrated components (other than the client 165) that are not based within the cloud computing environment 214, cloud connectors (not shown in FIG. 2B) may be used to interface those components with the cloud computing environment 214. Such cloud connectors may, for example, execute on WINDOWS Server instances hosted in resource locations, and may create a reverse proxy to route traffic between the site(s) and the cloud-computing environment 214. In the illustrated example, the cloud-based resource management services 202 include a client interface service 216, an identity service 218, a resource feed service 220, and a single sign-on service 222. As shown, in some embodiments, the client 165 may use a resource access application 224 to communicate with the client interface service 216 as well as to present a user interface on the client 165 that a user 226 can operate to access the resource feed(s) 206 and/or the SaaS application(s) 210. The resource access application 224 may either be installed on the client 165, or may be executed by the client interface service 216 (or elsewhere in the system 200) and accessed using a web browser (not shown in FIG. 2B) on the client 165.

As explained in more detail below, in some embodiments, the resource access application 224 and associated components may provide the user 226 with a personalized, all-in-one interface enabling instant and seamless access to all the user’s SaaS and web applications, files, virtual Windows applications, virtual Linux applications, desktops, mobile applications, Citrix Virtual Apps and Desktops™, local applications, and other data deployed across multiple locations for geo-redundancy.

When the resource access application 224 is launched or otherwise accessed by a respective client 165, the client interface service 216 may send a sign-on request to the identity service 218. In some embodiments, the identity provider 212 may be located on the premises of the organization for which the system 200 is deployed. The identity provider 212 may, for example, correspond to an on-premises WINDOWS Active Directory. In such embodiments, the identity provider 212 may be connected to the cloud-based identity service 218 using a cloud connector (not shown in FIG. 2B), as described above. Upon receiving a sign-on request, the identity service 218 may cause the resource access application 224 (via the client interface service 216) to prompt the user 226 for the user’s authentication credentials (e.g., user-name and password). Upon receiving the user’s authentication credentials, the client interface service 216 may pass the credentials along to the identity service 218, and the identity service 218 may, in turn, forward them to the identity provider 212 for authentication, for example, by comparing them against an Active Directory domain. Once the identity service 218 receives confirmation from the identity provider 212 that the user’s identity has been properly authenticated, the client interface service 216 may send a request to the resource feed service 220 for a list of subscribed resources for the user 226.

In other embodiments (not illustrated in FIG. 2B), the identity provider 212 may be a cloud-based identity service, such as a MICROSOFT AZURE Active Directory. In such embodiments, upon receiving a sign-on request from the client interface service 216, the identity service 218 may, via the client interface service 216, cause the client 165 to be redirected to the cloud-based identity service to complete an authentication process. The cloud-based identity service may then cause the client 165 to prompt the user 226 to enter the user’s authentication credentials. Upon determining the user’s identity has been properly authenticated, the cloud-based identity service may send a message to the resource access application 224 indicating the authentication attempt was successful, and the resource access application 224 may then inform the client interface service 216 of the successfully authentication. Once the identity service 218 receives confirmation from the client interface service 216 that the user’s identity has been properly authenticated, the client interface service 216 may send a request to the resource feed service 220 for a list of subscribed resources for the user 226.

For the configured resource feeds, the resource feed service 220 may request an identity token from the single sign-on service 222. The resource feed service 220 may then pass the feed-specific identity tokens it receives to the points of authentication for the respective resource feeds 206. The resource feed 206 may then respond with a list of resources configured for the respective identity. The resource feed service 220 may then aggregate all items from the different feeds and forward them to the client interface service 216, which may cause the resource access application 224 to present a list of available resources on a user interface of the client 165. The list of available resources may, for example, be presented on the user interface of the client 165 as a set of selectable icons or other elements corresponding to accessible resources. The resources so identified may, for example, include one or more virtual applications and/or desktops (e.g., Citrix Virtual Apps and Desktops™, VMware Horizon, Microsoft RDS, etc.), one or more file repositories and/or file sharing systems (e.g., Sharefile®, one or more secure browsers, one or more internet enabled devices or sensors, one or more local applications installed on the client 165, and/or one or more SaaS applications 210 to which the user 226 has subscribed. The lists of local applications and the SaaS applications 210 may, for example, be supplied by resource feeds 206 for respective services that manage which such applications are to be made available to the user 226 via the resource access application 224. Examples of SaaS applications 210 that may be managed and accessed as described herein include Microsoft Office 365 applications, SAP SaaS applications, Workday applications, etc.

For resources other than local applications and the SaaS application(s) 210, upon the user 226 selecting one of the listed available resources, the resource access application 224 may cause the client interface service 216 to forward a request for the specified resource to the resource feed service 220. In response to receiving such a request, the resource feed service 220 may request an identity token for the corresponding feed from the single sign-on service 222. The resource feed service 220 may then pass the identity token received from the single sign-on service 222 to the client interface service 216 where a launch ticket for the resource may be generated and sent to the resource access application 224. Upon receiving the launch ticket, the resource access application 224 may initiate a secure session to the gateway service 208 and present the launch ticket. When the gateway service 208 is presented with the launch ticket, it may initiate a secure session to the appropriate resource feed and present the identity token to that feed to seamlessly authenticate the user 226. Once the session initializes, the client 165 may proceed to access the selected resource.

When the user 226 selects a local application, the resource access application 224 may cause the selected local application to launch on the client 165. When the user 226 selects a SaaS application 210, the resource access application 224 may cause the client interface service 216 request a one-time uniform resource locator (URL) from the gateway service 208 as well a preferred browser for use in accessing the SaaS application 210. After the gateway service 208 returns the one-time URL and identifies the preferred browser, the client interface service 216 may pass that information along to the resource access application 224. The client 165 may then launch the identified browser and initiate a connection to the gateway service 208. The gateway service 208 may then request an assertion from the single sign-on service 222. Upon receiving the assertion, the gateway service 208 may cause the identified browser on the client 165 to be redirected to the logon page for identified SaaS application 210 and present the assertion. The SaaS may then contact the gateway service 208 to validate the assertion and authenticate the user 226. Once the user has been authenticated, communication may occur directly between the identified browser and the selected SaaS application 210, thus allowing the user 226 to use the client 165 to access the selected SaaS application 210.

In some embodiments, the preferred browser identified by the gateway service 208 may be a specialized browser embedded in the resource access application 224 (when the resource application is installed on the client 165) or provided by one of the resource feeds 206 (when the resource access application 224 is located remotely) (e.g., via a secure browser service). In such embodiments, the SaaS applications 210 may incorporate enhanced security policies to enforce one or more restrictions on the embedded browser. Examples of such policies include (1) requiring use of the specialized browser and disabling use of other local browsers, (2) restricting clipboard access (e.g., by disabling cut/copy/paste operations between the application and the clipboard), (3) restricting printing (e.g., by disabling the ability to print from within the browser), (3) restricting navigation (e.g., by disabling the next and/or back browser buttons), (4) restricting downloads (e.g., by disabling the ability to download from within the SaaS application), and (5) displaying watermarks (e.g., by overlaying a screen-based watermark showing the username and IP address associated with the client 165 such that the watermark will appear as displayed on the screen if the user tries to print or take a screenshot). Further, in some embodiments, when a user selects a hyperlink within a SaaS application, the specialized browser may send the URL for the link to an access control service (e.g., implemented as one of the resource feed(s) 206) for assessment of its security risk by a web filtering service. For approved URLs, the specialized browser may be permitted to access the link. For suspicious links, however, the web filtering service may have the client interface service 216 send the link to a secure browser service, which may start a new virtual browser session with the client 165, and thus allow the user to access the potentially harmful linked content in a safe environment.

In some embodiments, in addition to or in lieu of providing the user 226 with a list of resources that are available to be accessed individually, as described above, the user 226 may instead be permitted to choose to access a streamlined feed of event notifications and/or available actions that may be taken with respect to events that are automatically detected with respect to one or more of the resources. This streamlined resource activity feed, which may be customized for each user 226, may allow users to monitor important activity involving all of their resources-SaaS applications, web applications, Windows applications, Linux applications, desktops, file repositories and/or file sharing systems, and other data through a single interface, without needing to switch context from one resource to another. Further, event notifications in a resource activity feed may be accompanied by a discrete set of user-interface elements (e.g., “approve,” “deny,” and “see more detail” buttons), allowing a user to take one or more simple actions with respect to each event right within the user’s feed. In some embodiments, such a streamlined, intelligent resource activity feed may be enabled by one or more micro-applications, or “microapps,” that can interface with underlying associated resources using APIs or the like. The responsive actions may be user-initiated activities that are taken within the microapps and that provide inputs to the underlying applications through the API or other interface. The actions a user performs within the microapp may, for example, be designed to address specific common problems and use cases quickly and easily, adding to increased user productivity (e.g., request personal time off, submit a help desk ticket, etc.). In some embodiments, notifications from such event-driven microapps may additionally or alternatively be pushed to clients 165 to notify a user 226 of something that requires the user’s attention (e.g., approval of an expense report, new course available for registration, etc.).

FIG. 2C is a block diagram similar to that shown in FIG. 2B but in which the available resources (e.g., SaaS applications, web applications, Windows applications, Linux applications, desktops, file repositories and/or file sharing systems, and other data) are represented by a single box 228 labeled “systems of record,” and further in which several different services are included within the resource management services block 202. As explained below, the services shown in FIG. 2C may enable the provision of a streamlined resource activity feed and/or notification process for a client 165. In the example shown, in addition to the client interface service 216 discussed above, the illustrated services include a microapp service 230, a data integration provider service 232, a credential wallet service 234, an active data cache service 236, an analytics service 238, and a notification service 240. In various embodiments, the services shown in FIG. 2C may be employed either in addition to or instead of the different services shown in FIG. 2B.

In some embodiments, a microapp may be a single use case made available to users to streamline functionality from complex enterprise applications. Microapps may, for example, utilize APIs available within SaaS, web, or homegrown applications allowing users to see content without needing a full launch of the application or the need to switch context. Absent such microapps, users would need to launch an application, navigate to the action they need to perform, and then perform the action. Microapps may streamline routine tasks for frequently performed actions and provide users the ability to perform actions within the resource access application 224 without having to launch the native application. The system shown in FIG. 2C may, for example, aggregate relevant notifications, tasks, and insights, and thereby give the user 226 a dynamic productivity tool. In some embodiments, the resource activity feed may be intelligently populated by utilizing machine learning and artificial intelligence (AI) algorithms. Further, in some implementations, microapps may be configured within the cloud-computing environment 214, thus giving administrators a powerful tool to create more productive workflows, without the need for additional infrastructure. Whether pushed to a user or initiated by a user, microapps may provide short cuts that simplify and streamline key tasks that would otherwise require opening full enterprise applications. In some embodiments, out-of-the-box templates may allow administrators with API account permissions to build microapp solutions targeted for their needs. Administrators may also, in some embodiments, be provided with the tools they need to build custom microapps.

Referring to FIG. 2C, the systems of record 228 may represent the applications and/or other resources the resource management services 202 may interact with to create microapps. These resources may be SaaS applications, legacy applications, or homegrown applications, and can be hosted on-premises or within a cloud computing environment. Connectors with out-of-the-box templates for several applications may be provided and integration with other applications may additionally or alternatively be configured through a microapp page builder. Such a microapp page builder may, for example, connect to legacy, on-premises, and SaaS systems by creating streamlined user workflows via microapp actions. The resource management services 202, and in particular the data integration provider service 232, may, for example, support REST API, JSON, OData-JSON, and 6ML. As explained in more detail below, the data integration provider service 232 may also write back to the systems of record, for example, using OAuth2 or a service account.

In some embodiments, the microapp service 230 may be a single-tenant service responsible for creating the microapps. The microapp service 230 may send raw events, pulled from the systems of record 228, to the analytics service 238 for processing. The microapp service may, for example, periodically pull active data from the systems of record 228.

In some embodiments, the active data cache service 236 may be single-tenant and may store all configuration information and microapp data. It may, for example, utilize a per-tenant database encryption key and per-tenant database credentials.

In some embodiments, the credential wallet service 234 may store encrypted service credentials for the systems of record 228 and user OAuth2 tokens.

In some embodiments, the data integration provider service 232 may interact with the systems of record 228 to decrypt end-user credentials and write back actions to the systems of record 228 under the identity of the end-user. The write-back actions may, for example, utilize a user’s actual account to ensure all actions performed are compliant with data policies of the application or other resource being interacted with.

In some embodiments, the analytics service 238 may process the raw events received from the microapps service 230 to create targeted scored notifications and send such notifications to the notification service 240.

Finally, in some embodiments, the notification service 240 may process any notifications it receives from the analytics service 238. In some implementations, the notification service 240 may store the notifications in a database to be later served in a notification feed. In other embodiments, the notification service 240 may additionally or alternatively send the notifications out immediately to the client 165 as a push notification to the user 226.

In some embodiments, a process for synchronizing with the systems of record 228 and generating notifications may operate as follows. The microapp service 230 may retrieve encrypted service account credentials for the systems of record 228 from the credential wallet service 234 and request a sync with the data integration provider service 232. The data integration provider service 232 may then decrypt the service account credentials and use those credentials to retrieve data from the systems of record 228. The data integration provider service 232 may then stream the retrieved data to the microapp service 230. The microapp service 230 may store the received systems of record data in the active data cache service 236 and also send raw events to the analytics service 238. The analytics service 238 may create targeted scored notifications and send such notifications to the notification service 240. The notification service 240 may store the notifications in a database to be later served in a notification feed and/or may send the notifications out immediately to the client 165 as a push notification to the user 226.

In some embodiments, a process for processing a user-initiated action via a microapp may operate as follows. The client 165 may receive data from the microapp service 230 (via the client interface service 216) to render information corresponding to the microapp. The microapp service 230 may receive data from the active data cache service 236 to support that rendering. The user 226 may invoke an action from the microapp, causing the resource access application 224 to send that action to the microapp service 230 (via the client interface service 216). The microapp service 230 may then retrieve from the credential wallet service 234 an encrypted OAuth2 token for the system of record for which the action is to be invoked, and may send the action to the data integration provider service 232 together with the encrypted OAuth2 token. The data integration provider service 232 may then decrypt the OAuth2 token and write the action to the appropriate system of record under the identity of the user 226. The data integration provider service 232 may then read back changed data from the written-to system of record and send that changed data to the microapp service 230. The microapp service 230 may then update the active data cache service 236 with the updated data and cause a message to be sent to the resource access application 224 (via the client interface service 216) notifying the user 226 that the action was successfully completed.

In some embodiments, in addition to or in lieu of the functionality described above, the resource management services 202 may provide users the ability to search for relevant information across all files and applications. A simple keyword search may, for example, be used to find application resources, SaaS applications, desktops, files, etc. This functionality may enhance user productivity and efficiency as application and data sprawl is prevalent across all organizations.

In other embodiments, in addition to or in lieu of the functionality described above, the resource management services 202 may enable virtual assistance functionality that allows users to remain productive and take quick actions. Users may, for example, interact with the “Virtual Assistant” and ask questions such as “What is Bob Smith’s phone number?” or “What absences are pending my approval?” The resource management services 202 may, for example, parse these requests and respond because they are integrated with multiple systems on the back-end. In some embodiments, users may be able to interact with the virtual assistance functionality either through the resource access application 224 or directly from another resource, such as Microsoft Teams. This feature may allow employees to work efficiently, stay organized, and deliver only the specific information they are looking for.

### C. POP Network Architecture

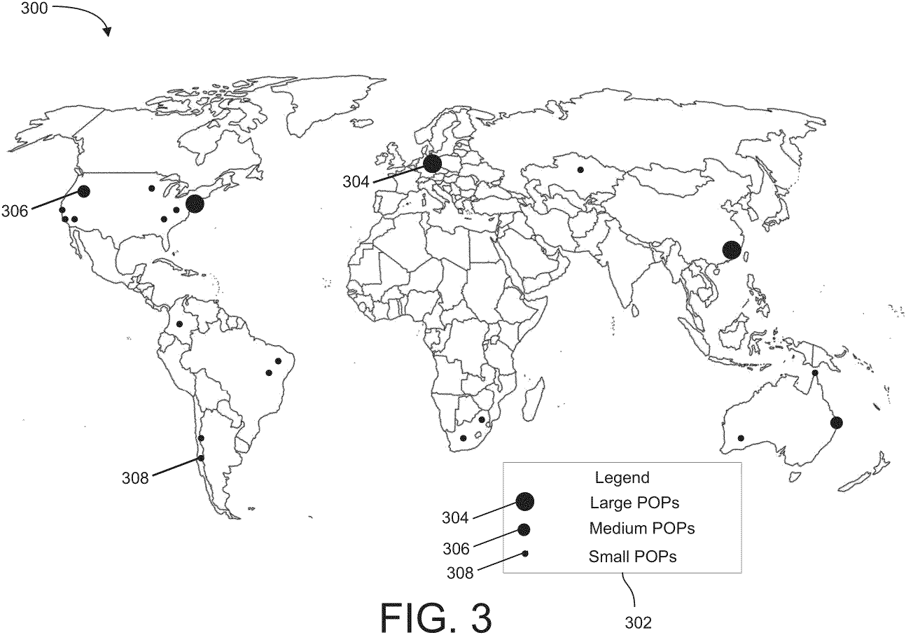

Referring now to FIG. 3, a map diagram 300 of the locations of one or more points of presence (POPs) is shown in accordance with an illustrative embodiment. As shown in FIG. 3, POPs may be located at multiple locations throughout the world. POPs may be defined as access points or locations at which two or more network devices may connect. For example, a local internet POP may allow a network device or user equipment (e.g., such as client devices 165a-165n) to connect (e.g., through an internet service provider) to a server hosting a resource. In some embodiments, a POP may be a data center which may include a collection of telecommunication equipment. The telecommunication equipment may be configured to facilitate access between the network devices and the internet. In some embodiments, the telecommunication equipment that make up the POPs may include routers, network switches, servers, multiplexers, or other telecommunication not explicitly mentioned herein.

In some embodiments, POPs may be described using one or more identifiers that may differentiate that specific POP from other POPs. These identifiers may include the vendor or manager of the POP (Amazon Web Services, Google Cloud, Microsoft Azure, IBM Cloud, Oracle Cloud, Alibaba Cloud, etc.), the location of the POP (e.g., country, region, state, etc.), or any other identifiers (e.g., device names, numbers, etc.) that may be used to identify the POP.

In some embodiments, the collection of POPs which are located at a common or shared data center may referred to as an “access point.” The access points may be located at various geographic locations throughout the world as shown on map diagram 300. An access point may be defined as a specific physical location, such as a building or facility, where the telecommunication equipment may be stored, maintained, and operated to create the POPs. Access points which include various number of POPs may range in size from large to small, to meet the specific needs of the network devices as shown in map diagram legend 302. More specifically, the map diagram 300 includes large POPs 304 (e.g., access points including a large number of POPs 304), medium POPs 306, and small POPs 308. For example, carrier hotels are a larger type of access point or colocation with a large amount of POPs. Larger carrier hotels may be used for website hosting for large companies, storage service providers, and telecommunication companies. As another example, a medium size POP access point may be an ISP configured to connect network devices to their internet service provider. As a final example, a smaller size POP access point may be a single server.

Applications may be deployed on a client device over a network (e.g., internet, wireless, cloud, etc.) through one or more POPs. More specifically, the applications may be deployed on one or more cloud platform (or cloud networks). Cloud platforms may be described as a combination of one or more POPs that are located at multiple different locations that form a network by which cloud computing services can be performed and applications may be deployed.

One of the primary challenges that is faced by application managers which wish to deploy the application on the client device over a network through one or more POPs is selecting which POP or combination of POPs to use to deploy the application. There are several factors that may be considered when selecting which POP or combination of POPs to use when deploying the application. These factors may include the cost of using a particular POP or combination of POPs, the privacy and network security of using a particular POP or combination of POPs, and which POP or combination of POPs may have the best performance. However, which POP or combination of POPs has the best performance may be difficult to gauge because it may not be clear what exactly constitutes a “best performing POP or combination of POPs”.

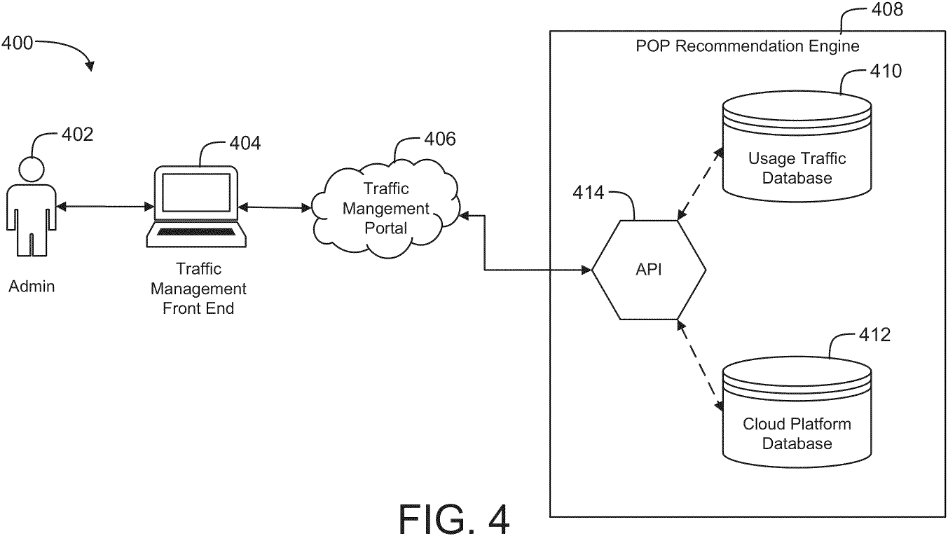

The systems and methods described herein address this challenge of determining a “best performing POP or combination of POPs”. More specifically, the systems and methods described herein include a POP recommendation engine that evaluates each POP or combination of POPs to determine the best performance and make a recommendation of which POPs the application manager may use to deploy their application based on that determination. The POP recommendation engine considers one or more characteristics of the POPs,, RUMs, and/or the application being deployed when determining best performance and making a recommendation as will be described in more detail below with respect to FIG. 4.

RUMs refer to real time metrics collected from user browsers or native apps towards a list of access points including various different cloud platforms and content delivery networks (CDNs). These metrics are dynamically collected and aggregated (e.g., in real-time or substantially in real-time at various intervals) to create performance scores (availability, latency and throughput) from various geographic regions (e.g., continent, country, region, state, locality, etc.) and networks towards a list of cloud POPs and CDNs. The POP recommendation engine takes advantage of the rich data set of RUMs to provide the best combination of POPs either per cloud platform vendor or by combining several different cloud platform vendors. The POP recommendations may be based on an evaluation of the RUMs during a predefined time-window or predefined time instance.

Current systems may not address the challenge of identifying the best performing POPs based on the RUMs, but instead may rely on use cost and proximity factors to select the POPs for deploying an application. There are many drawbacks associated with current systems of determining the performance of POPs and making recommendations. For example, the current systems and do not consider multi-cloud capabilities as are contemplated in the systems and methods herein. For example, cloud platforms such as GOOGLE and AMAZON may provide services that identify the “best performing POPs” within their own specific platforms. However, they do not provide a system to evaluate and compare POPs associated with different cloud platforms or to set a traffic distribution mix (e.g., percentage of the traffic distribution per continent, country, state, region, etc.) using different cloud platforms. Another drawback of the current systems and methods is that they may only consider user traffic distribution on a country level but do not consider user traffic distribution on a more granular level (e.g., state, province, region, county, city, zip code, etc.). Considering traffic distribution on a more granular level may be beneficial in certain larger countries (e.g., the United States, China, Canada, Russia, etc.), where user network traffic may vary significantly by state, city or region leading to a POP selection being based heavily on the distribution of network traffic between different states. Therefore, the systems and methods as described herein, which utilize more granular user traffic distribution data to determine the performance of one or more POPs make recommendations on which POP or combination of POPs may be used to deploy an application, may be desired. Another drawback of the current systems and methods is that do not provide a performance report comparing one recommendation versus another. An important factor that drives the decision of which POP or combination of POPs to use to deploy application is the performance difference or latency between each of the POP recommendation options.

### D. Systems and Methods for Generating POP Recommendations

Referring now to FIG. 4, a block diagram of a POP recommendation system 400 is shown in accordance with an illustrative embodiment. The POP recommendation system 400 may configured to evaluate one or more POPs (e.g., across various cloud platform providers) and provide a recommendation of which POP or combination of POPs may be used to deploy an application. As described above, the POP recommendation system 400 considers a variety of factors and characteristics of POPs to evaluate each POP and provide a recommendation. More specifically, these factors may include real user measurements (RUMs), costs, and proximity. The POP recommendation system 400 then provides this recommendation to an administrator or manager of an application.

The POP recommendation system 400 may include a traffic management front end 404 accessible by an administrative user or admin 402, a traffic management portal 406, and a POP recommendation engine 408. The admin 402 may be an application manager or administrator which manages an application to be deployed (or is currently deployed). The application manager / administrator may generate a request (e.g., via the traffic management front end 404) to the traffic management portal 406 to determine which POPs (or combination of POPs) should be used to deploy the application. When the admin 402 is deploying an application using one or more POPs, the admin 402 may submit a request (e.g., using / via the traffic management front end 404) for a recommendation from the POP recommendation engine 408. A POP recommendation may be described as a recommendation of which POP or combination of POPs that may be used to deploy an application, based on a determination of the performance of the POP or combination of POPs. The POP recommendation may be determined by the POP recommendation engine 408 as will be described in more detail below.

The traffic management front end 404 may be a user device such as a laptop, computer, or mobile device. The traffic management front end 404 may be configured to receive a POP recommendation request from the admin 402 and send the POP recommendation request to the POP recommendation engine 408 through the traffic management portal 406. Additionally, the traffic management front end 404 may be configured to receive a POP recommendation from the POP recommendation engine 408 through the traffic management portal 406 and display the received POP recommendation to the admin 402.

In some instances, the POP recommendation request submitted using the traffic management front end 404 may be a proper Hypertext Transfer Protocol (HTTP) request. For the proper HTTP request to be considered a proper request, the traffic management front end 404 may be configured to determine whether HTTP request may include certain parameters (e.g., fixed parameters which require a value to be specified for the HTTP request to deemed “proper”). For example, the fixed parameters may include a list of cloud providers, a list of countries / regions / etc. to be considered by the POP recommendation engine 408, traffic distributions across the regions, etc. Each of these fixed parameters are described in greater detail below.

The fixed parameters may include a list of cloud platforms to be considered by the POP recommendation engine 408. In some embodiments, the cloud platforms may include, but are not limited to, Amazon Web Services, Google Cloud, Microsoft Azure, IBM Cloud, Oracle Cloud, Alibaba Cloud. The fixed parameters may include a list of rules or policies, including constraints on the costs, network security, or privacy for constraining the POP recommendations provided by the POP recommendation engine 408. For example, the admin 402 may request the POP recommendation engine 408 to only provide POPs recommendations which would cost under a certain threshold. The cost of one or more POPs may refer the amount of money needed to have access to the POPs and utilize the POPs to deploy an application. In some cases, the cost of one or more POPs may be based on usage traffic for the application. For example, an application with higher usage traffic may have a higher cost than an application with lower usage traffic. The cost of one or more POPs may also vary based on the cloud provider to which the POP belongs. For example, POPs on the Google Cloud may have different costs than those on Amazon Web Services. The network security and/or privacy of the POP may refer to a variety of security measures that may be implemented to safeguard one or more POPs. These security measures may include but are not limited to network monitoring to protect the POPs from malicious or unauthorized traffic, network virus and malware protection, data encryption, user authentication, and application security. In some implementations, the fixed parameters may entered by the admin 402 through a user interface. For example, the admin may use a drop down box or push button on a user interface to select which cloud platforms to include in the POP recommendation request. As another example, the admin 402 may enter the list of rules or policies, such as constraints on the cost, the POP size, the network security, and data privacy/compliance, in a text box within a user interface.

In some embodiments, the HTTP request may include a list of regions to be considered by the POP recommendation engine 408. The regions may also include a list of countries, regions within countries, states, counties, zip codes, or any other geographical groupings which is requested to be considered by the POP recommendation engine 408.

In some embodiments, the HTTP request may include a traffic distribution across the list of regions. The user traffic distribution may be defined as a percentage of application traffic origination from specific user location. For example, the percentage of application traffic may include percentages of traffic which originates from clients which access (or are likely to access) the application and are located in certain countries, states, regions, or cities. The user traffic distribution may be determined based on the RUMs. Additionally, the fixed parameters may include traffic distributions across each of the countries to be considered by the POP recommendation engine 408. In some embodiments, the list of traffic distributions for each of the countries may not be entered directly to the traffic management front end 404 by the admin 402, but instead may be pulled from a usage traffic database 410 based on the list of countries themselves. In some embodiments, the list of traffic distributions may be constrained based on cost, size of the POP, network security, and data privacy/compliance requirements. More specifically, if an application is currently deployed, the POP recommendation engine 408 may use RUMs for user access to the application to determine the traffic distribution of the application for the countries included in the HTTP request. The RUMs may be stored in the usage traffic database 410. Additionally, the certain parameters may include a list of traffic distributions for each of the states, regions, counties, zip codes, and/or any other geographical groupings the user requests to be considered by the POP recommendation engine 408. The list of traffic distributions for each of the states, regions, counties, zip codes, and/or any geographical identifiers the user requests to be considered may not be entered directly to the traffic management front end 404 by the admin 402 but instead may be pulled from a usage traffic database 410 based on the list of states, regions, counties, zip codes, and/or any geographical identifiers the user requests to be considered. Again, based on the application being currently deployed, the POP recommendation engine 408 may use the RUMs for user access to the application to determine the traffic distribution of the application for the states, regions, counties, zip codes, and/or any geographical identifiers included in the HTTP request.

In some embodiments, one or more of the parameters detailed above may be required while others are optional. For example, in one embodiment, the list of countries the admin 402 requests to be considered by the POP recommendation engine 408 may be a required parameter in the proper HTTP request while the list of states, regions, counties, zip codes, or any other geographical groupings and the list of cloud platforms the admin 402 requests to be considered by the POP recommendation engine 408 may be optional parameters in the proper HTTP request.

Once the user enters the POP recommendation request as a proper HTTP request (e.g., by providing any fixed parameters / values in the request), the traffic management front end 404 may be configured to transmit, send, or otherwise provide the HTTP request to the traffic management portal 406. In some embodiments, the traffic management portal 406 may configured to authenticate the admin 402 (e.g., ensure that the admin 402 has the permissions to submit a POP recommendation request), validate that the HTTP request is a valid and proper HTTP request, and generally facilitate communication between the user and the POPs recommendation engine 208. All valid HTTP requests are sent to the POP recommendation engine 408 once they have been validated by the traffic management portal 406.

The PoPs recommendation engine 408 may be configured to evaluate the POP recommendation requests and determines a recommendation of which POP or combination of POPs may be used to deploy an application. The POP recommendation engine 408 leverages RUMs and user traffic distributions determined from the RUMs, in addition to cost metrics and network security/privacy metrics to provide recommendation about which POP or combination of POPs may be used to deploy an application. The RUMs may be defined as real-time metrics collected from user browsers or native applications towards a large list of endpoints including all major cloud platforms (Amazon Web Services, Google Cloud, Microsoft Azure, IBM Cloud, Oracle Cloud, Alibaba Cloud, etc.) and content delivery networks (e.g., Google cloud CDN, Amazon Web Services CDN, Azure CDN). In some embodiments, the RUMs may be based on traffic data collected from browsers and applications not associated with the application that the admin 402 is seeking a POP recommendation (e.g., from other third-party applications/ resources), to determine which POPs to use to deploy the application. For example, the POP recommendation engine generates a POP recommendation for deploying Application A based on real user measures of multiple different users accessing a wide variety of applications (e.g., Applications B-Z) through a variety of different POPs, cloud platforms, and/or CDNs.

These metrics (e.g., the RUMs) may be collected by the POP recommendation engine 408, and are aggregated to create performance metrics (availability, latency, throughput, etc.) for a variety of different physical locations (e.g., continents, countries, states, regions, etc.). In some embodiments, the RUMs may be stored in the cloud platform database 412. The performance metrics may then be used to create a list of POPs (including the POPs′ respective cloud platforms and location) ranked according to the POP’s performance metrics. The POP recommendation engine 408 takes advantage of data set created by the RUMs to provide a recommendation of the best combinations of POPs based on one or more parameters set by the admin 402. The one or more parameters set by the admin 402 may be the parameters included in the proper HTTP request as described above.

The POP recommendation engine 408 includes a recommendation engine API 414, the usage traffic database 410, and the cloud platform database 412. The recommendation engine API 414 may be configured to receive, analyze, and serve the incoming HTTP requests. The recommendation engine API 414 receives the proper HTTP request from the traffic management portal 406, evaluates the parameters included in the proper HTTP request (e.g., the list of countries the user requests to be considered, the list of traffic distributions for each of the countries the user requests to be considered, etc.). In the embodiments in which the HTTP request includes a list of countries, the recommendation engine API 414 defines a list of countries, along with their corresponding usage breakdown distribution percentages, for the POP recommendation engine 408 to consider. Furthermore, in embodiments where the proper HTTP request includes a list of states, regions, counties, zip codes, or any other geographical groupings the user requests to be considered, the list of traffic distributions for each of the states, regions, counties, zip codes, or any other geographical groupings the user requests to be considered, the recommendation engine API 414 may define a list of states, regions, counties, zip codes, or any other geographical groupings, along with their corresponding usage breakdown distribution percentages, for the POP recommendation engine 408 to consider. Finally, in embodiments where the proper HTTP request includes a list of cloud platforms the user requests to be considered, the recommendation engine API 414 may define a list of cloud regions for the POP recommendation engine 408 to consider. In embodiments where the HTTP request does not specify or provide a defined list of cloud platforms, the recommendation engine 408 may be configured to consider all the cloud platforms stored in the cloud platform database 412.

The cloud platform database 412 may be configured to store the network performance data of one or more cloud platforms by location (e.g., country, state, region, etc.) as determined by the RUMs. In some embodiments, the network performance data may be telemetry data as measured by a traffic management radar telemetry mechanism (not shown). The POP recommendation engine 408 not only measures the network performance of the current POP/POPs being used to run the application that is currently deployed, but also includes a back end service running on the traffic management front end 404 (e.g., user device) that measures the performance metrics of any other POPs not currently being used by the client device or application. In some embodiments, the network performance data may be collected, aggregated, and stored in certain time increments (e.g., daily, weekly, monthly, quarterly, etc.). In other embodiments, the network performance data may be collected, aggregated, and stored continuously and in real time. The network performance data may include one or more network metrics, such as an average median round trip time (RTT) (in milliseconds), an average median throughput time (in kbps), an average availability (within the range of 0 to 100), an average median connection timeout, and an average median pTCP score. The average median pTCP score may be defined as the extended average median RTT time of the cloud platform that also considers its availability. For example, a POP may have an average median connection timeout of 4000 milliseconds. In this case, the pTCP score may be calculated based on Equation 1 below.

$$\begin{matrix}p T C P = a v a i l a b i l i t y r a t i o ∗ R T T + \left(1 - a v a i l a b i l i t y\right) ∗ c o n n e c t i o n \\ t i m e o u t t i m e\end{matrix} \qquad \text{(1)}$$

Once the POP recommendation engine 408 receives the POP recommendation request, the POP recommendation engine 408 retrieves the performance data from the cloud platform database 412 for a previous time period (e.g., previous week, two weeks, month, or other period of time) regarding the specified locations of interest. The POP recommendation engine 408 may be configured to determine one or more network metrics from the network performance data, to evaluate each POP in comparison to one or more other POPs to determine the relative performance of the POP. In some embodiments, all of the network metrics listed above may be used to evaluate the POPs while in other embodiments, only some of the network metrics listed above. For example, the POP or combination of POPs that may be recommended by POP recommendation engine 408 may be evaluated based on the pTCP score.

The usage traffic database 410 may be configured to store the RUMs which describes real-time metrics collected from user browsers or native applications towards a large list of endpoints including all major cloud platforms. The user traffic distribution data may be categorized based on country, state, region, county, zip code, or any other geographical grouping. In some embodiments, the user traffic distribution data may be determined based on the RUMs.

To evaluate and determine the performance of each POP or combination of POPs to determine a recommendation of which POP or combination of POPs to use to deploy an application, the POP recommendation engine 408 determines one or more performance metrics which may be used to evaluate each POP or combination of POPs. In some embodiments, the performance metrics may include a round robin RTT time which is the average RTT value of the median RTT’s weighted average per POP per location. In some embodiments, the performance metrics may include a traffic management optimal RTT time which is the weighted average of each POP within a combination of POPs, with the lowest calculated media RTT per location. In some embodiments, the performance metrics may include a geographical optimal RTT time which is the weighted average of each POP within a combination of POPs, which is geographically closest to the location where the application will be deployed, per distinct location.

In some embodiments, the POP recommendation engine 408 may be configured to perform the recommendation analysis by considering the calculated average median RTT for each POP, the locations included in the HTTP request, and all the different cloud service providers that the admin 402 has requested be considered. More specifically, the POP recommendation engine 408 may be configured to use equations (1), (2), and/or (3) to determine a performance score for each POP or combination of POPs to create a ranked recommendation list of the POP or combination of POPs that may have been evaluated as a response to the HTTP request. The ranked recommendation list may list the recommend POPs or combination of POPs from best performance (most recommended) to worst performance (least recommended). In some embodiments, the ranked recommendation list the recommend POPs or combination of POPs from worst performance (least recommended) to best performance (most recommended). The ranked listed may be constrained based on the policies or rules set by or otherwise defined in the HTTP request. For example, the HTTP request may constrain the POP evaluation to only certain POPs based on constraints on cost and/or network security or privacy as described above. Therefore, the ranked list may only rank POPs or combination of POPs that fit within this range. In some embodiments, the POP recommendation engine 408 to may customize the POP recommendation to extend the currently existing POP architecture that the admin 402 may have already implemented to deploy their application. More specifically, the POP recommendation engine 408 determines a ranked list using (1) after extending the currently existing POP architecture by one or more POPs. In some embodiments, the POP recommendation engine 408 may determine usage / metrics / characteristics for each of (or a subset of) the individual POPs from a ranked list in comparison to other POPs according to the round robin RTT, the optimal RTT, and geographical optimal RTT using the Equations 2 and 3 below.

$$I T M o v e r R o u n d R o b i n = \left(1 - \frac{I T M O p t i m a l R T T}{R o u n d R o b i n R T T}\right) ∗ 100 \qquad \text{(2)}$$

$$I T M o v e r G e o - P r o x i m i t y = \left(1 - \frac{I T M O p t i m a l R T T}{G e o O p t i m a l R T T}\right) ∗ 100 \qquad \text{(3)}$$

In some embodiments, the POP recommendation engine 408 may be configured to generate the recommendation (e.g., the ranked recommendation list) as a data object. A data object may be defined as a collection of data or information that may be used to transfer the data or information from one data entity to another. In some embodiments, the data object may be a JavaScript Object Notation (JSON object). The POP recommendation engine 408 may then be configured to transmit, send, or otherwise provide the data object via the traffic management portal 406 to the traffic management front end 404 for display to the admin 402. In some embodiments, the recommendation engine 408 may provide live POP recommendations to the admin 402 on a regular basis (e.g., every day, every week, every month, etc.) based on metrics from a prior time period (e.g., prior day, prior week, prior two weeks, prior month, etc.). The POP recommendations provided by the POP recommendation engine 408 can dynamically change from day to day based on the real time traffic distribution and RUMs collected the previous time period.

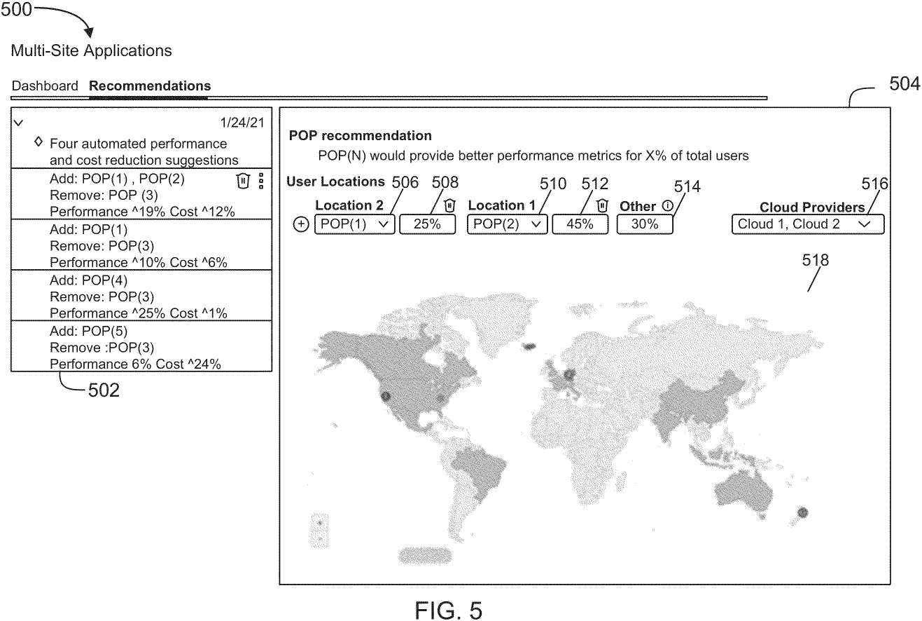

Referring now to FIG. 5, a diagram of a user interface 500 for displaying the results of the POP recommendation system 400 is shown in accordance with an illustrative embodiment. The user interface 500 may generated by the POP recommendation engine 408 and rendered on the traffic management front end 404. The user interface 500 that is configured to receive recommendation request from the user and the display the recommendation determined by the POP recommendation engine 408. The user interface 500 may include a POP recommendation panel 502 which is configured to provide the list of POP recommendations. In some embodiments, the POP recommendations may include adding a POP or cloud platform to the application deployment. In some embodiments, the POP recommendations may include removing a POP or cloud platform in the application deployment. The user interface 500 may include a POP recommendation detail panel 504 which is configured provide details of a POP recommendation. The admin 402 may be able to interact with one or more portions of the user interface 500 to input or update the POP recommendation request. For example, the admin 402 may then use the drop down menus 506 and 510 to input or update the locations in the POP recommendation request. As another example, the admin 402 may use the text box 508, 512, and 514 to input or update the usage distribution from each location in the HTTP request. As a final example, the admin 402 may use the drop down menu 516 to input or update the desired cloud platforms in the HTTP request. In some embodiments, The POP recommendations may be displayed on a map 518.

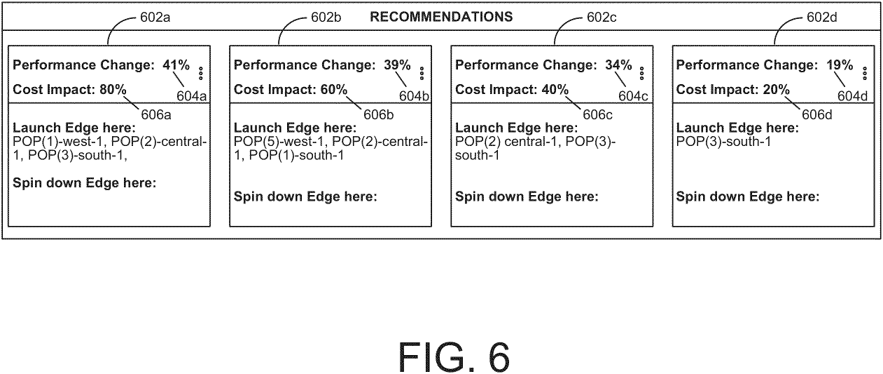

Referring now to FIG. 6, another diagram of a user interface 600 for displaying the results of the POP recommendation system 400 is shown in accordance with an illustrative embodiment. The user interface 600 may generated by the POP recommendation engine 408 and rendered on the traffic management front end 404. The user interface 600 is configured to display a comparative analysis of each POP or combinations of POPs which are included in the POP recommendation determined by the POP recommendation engine 408 for deploying the application. For example, user interface 600 includes four POP recommendations 602a-602d which may potentially be used to as a means for combinations for deploying the application. More specifically, the user interface 600 is used to compare the cost impacts and performance changes of each of the POP recommendations 602a-602c. The percent change in performance (as determined based on availability, latency, throughput, etc. as described above) is displayed at 604a-604d for each of the recommended combination of POPs. This percent change in performance is determined by comparing the recommended POPs combinations to the current POP architecture being used to deploy the application. The percent change in cost is displayed at 606a-606d for each of the POP recommendations. This percent change in performance is determined by comparing the recommended POPs combinations to the current POP architecture being used to deploy the application.

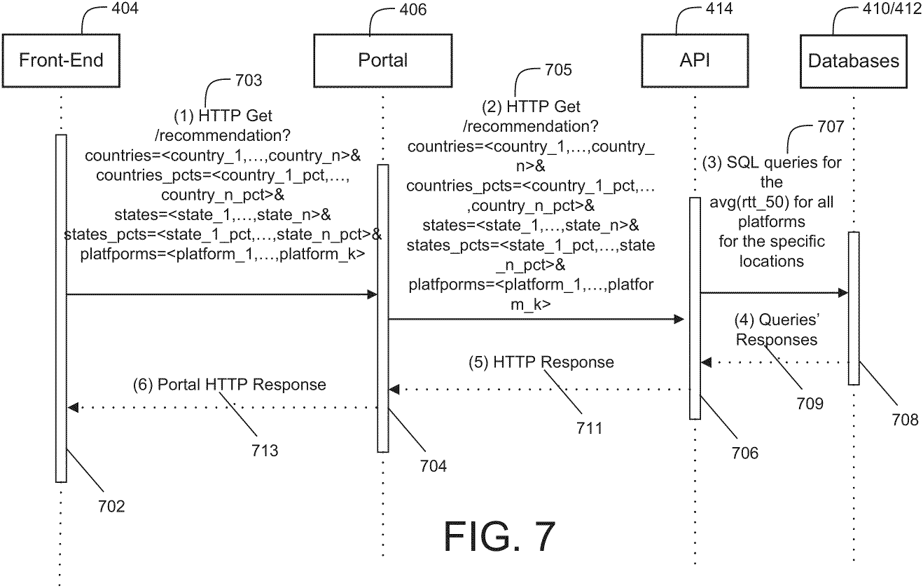

Referring now to FIG. 7, a sequential diagram 700 of a flow of data within the POP recommendation system 400 is shown in accordance with an illustrative embodiment. The sequential diagram 700 describes the interaction between different components of the POP recommendation system 400. More specifically, the sequential diagram 700 shows the flow of the HTTP request through the POP recommendation system 400 and the return of the response to the HTTP request to the traffic management front end 404.

At step 702, an HTTP request 703 is received by the traffic management front end 404 which then sends the HTTP request 703 to the traffic management portal 406. At step 704, the traffic management portal 406 verifies and validates the HTTP request 703 and the traffic management portal 406 sends the authenticated HTTP request 705 to recommendation engine API 414. At step 706, the recommendation engine API 414 parses the authenticated HTTP request 705 to generate an structured query language (SQL) query 707 to retrieve, request, or otherwise access the performance metrics for one or more POPs for the requested locations as specified in the authenticated HTTP request 705. The recommendation engine API 414 queries the cloud platform database 412 and/or usage traffic database 410 for performance metrics and user traffic data based on the generated SQU query 707. At step 708, the cloud platform database 412 and the usage traffic database 410 returns a response to the query. In some embodiments, the response to the SQU query 707 may be an average RTT for one or more POPs for the desired locations included HTTP request 705. The cloud platform database 412 may be configured to return, transmit, send, or otherwise provide the response to the SQU query 709 to the recommendation engine API 414. The recommendation engine API 414 may then be configured to analyze the response to the SQU query 709 (e.g., the average RTT and/or other POP performance metrics) and the other parameters included in the HTTP request to generate a response to the HTTP response 711. In some embodiments, the HTTP response 711 may be a POP recommendation including one or more POPs. In some embodiments, the HTTP response 711 may be a JSON object. The POP recommendation engine 408 may then be configured to transmit, send, or otherwise provide the HTTP response 711 to the traffic management portal 406. The traffic management portal 406 may be configured to send the HTTP response 713 to the traffic management front end 404 where it is displayed on a user interface (e.g., as shown in user interfaces 500 and 600 above).

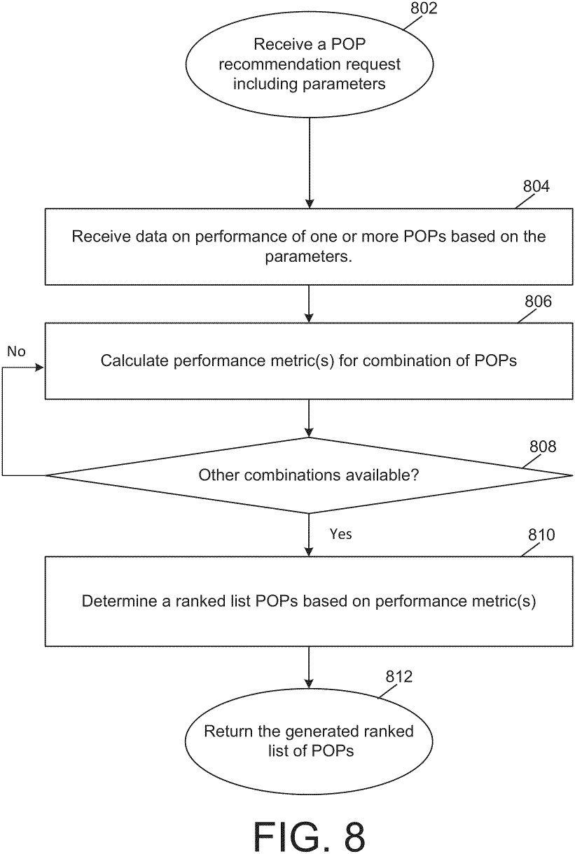

Referring now to FIG. 8, a diagram of a method 800 for generating a POP recommendation is shown in accordance with an illustrative embodiment. The components described in FIGS. 1-7, and/or the system 400 detailed above can perform the operations and functionalities of the method 800. In brief overview, the POP recommendation system 400 receives a POP recommendation request including parameters (Step 802). The POP recommendation system 400 then receives data on performance of one or more POPs based on the parameters. (Step 804). The POP recommendation system 400 calculates performance metric(s) for combination of POPs to evaluate the performance of each of the POPs or combination of POPs (Step 806). Then POP recommendation system 400 determines if each POP or combination of POPs has been evaluated (Step 808). If each POP or combination of POPs has not been evaluated, then the POP recommendation system 400 repeats Step 806 until each POP or combination of POPs has been evaluated. If each POP or combination of POPs has been evaluated, then the POP recommendation system 400 determines a ranked list of POPs based on performance metric(s) (Step 810). Then the POP recommendation system 400 returns the generated ranked list of POPs.

Referring now to FIG. 8 in more detail, the POP recommendation engine 400 receives a POP recommendation request from a user (e.g., admin 402) including one or more request parameters at Step 802. As explained above, the POP recommendation request may be a HTTP request entered by a user through a user device, such as the traffic management front end 404. The POP recommendation request may be received responsive to an indication received from the admin 402 to determine a recommendation for which POP or combination of POPs to use to deploy a new application, expand the application to new territories/regions/etc., and/or to update the POP or combination of POPs (e.g., different cloud provider) used to deploy the application. In some embodiments, the POP recommendation request may be in a different form, such as a HTTPS request.

In some embodiments, the POP recommendation request may include one or more parameters configured to define the POP recommendation. The one or more parameters may include a list of countries the admin 402 requests to be considered by the POP recommendation engine 408. Additionally, the one or more parameters may include a list of traffic distributions for each of the countries the user requests to be considered by the POP recommendation engine 408. The list of traffic distributions for each of the countries the user requests to be considered may not be entered directly to the traffic management front end 404 by the admin 402 but instead may be pulled from a usage traffic database 410 based on the list of countries the user requests to be considered by the POP recommendation engine 408.

The one or more parameters may also include a list of states, regions, counties, zip codes, or any other geographical groupings which the user requests to be considered by the POP recommendation engine 408. Additionally, the one or more parameters may include a list of traffic distributions for each of the states, regions, counties, zip codes, and/or any other geographical groupings the user requests to be considered by the POP recommendation engine 408. The list of traffic distributions for each of the states, regions, counties, zip codes, and/or any geographical identifiers the user requests to be considered may not be entered directly to the traffic management front end 404 by the admin 402 but instead may be pulled from a usage traffic database 410 based on the list of states, regions, counties, zip codes, and/or any geographical identifiers the user requests to be considered.

The one or more parameters may also include a list of cloud platforms which the user requests to be considered by the POP recommendation engine 408. In some embodiments, the cloud platforms may include, but are not limited to, Amazon Web Services, Google Cloud, Microsoft Azure, IBM Cloud, Oracle Cloud, and Alibaba Cloud. The one or more parameters may also include a list of rules or policies which the user requests to be considered by the POP recommendation engine 408. The POP recommendation request may then be verified and authenticated by the traffic management portal 406. Verification and authentication of the POP recommendation request may include determining that the user submitting the POP recommendation request is authorized to do so (e.g., an admin or manager of the application) and that all the required parameters are included the HTTP request. Verification and authentication may be based on the identification of the user, the location of the user, and the IP address associated with the user submitting the POP recommendation request.

After the POP recommendation request has been verified and authenticated by the traffic management portal 406, the traffic management portal 406 may then send the POP recommendation request to the POP recommendation engine 408. The POP recommendation engine 408 may receive data on the performance of one or more POPs or POP combinations based on location in the POP recommendation request parameters at Step 804. More specifically, the POP recommendation engine 408 may analyze the parameters of the POP recommendation request to determine what network performance data to pull from the usage traffic database 410 and cloud platform database 412 and what constraints to place on POP recommendations. For example, based on the location parameter in the POP recommendation request, the POP recommendation engine 408 can determine which countries, regions, states, etc. to include or exclude in the POP recommendation. For example, the admin 402 may request to deploy their application only using POPs in the United States. As another example, based on the cloud platforms parameter in the HTTP request, the recommendation engine can determine which cloud platforms to use to include or exclude in the recommendation. For example, Company A may have a contract with Amazon Web Services (AWS) so they may only request to include combinations of POPs hosted on the AWS cloud platform in the recommendations. In this case, the POP recommendation engine 408 may only pull network performance data for the POPs hosted on the AWS cloud platform.

The network data may then be used by the POP recommendation engine 408 to calculate performance metric(s) for each POP or combination of POPs. In some embodiments, the network performance data may be collected, aggregated, and stored in certain time increments (e.g., daily, weekly, monthly, quarterly, etc.). In other embodiments, the network performance data may be collected, aggregated, and stored continuously and in real time. The network performance data may include one or more network metrics such as an average median round trip time (RTT) (in milliseconds), an average median throughput time (in kbps), an average availability (within the range of 0 to 100), an average median connection timeout, and an average median pTCP score. The average median pTCP score may be defined as the extended average median RTT time of the cloud platform that also considers its availability. For example, a POP may have an average median connection timeout of 4000 milliseconds. In this case, the pTCP score may be calculated based on (1) as described above. The network performance data is received for every POP and/or combination of POPs that fits within the POP recommendation request parameters.

After the performance data has been received from the usage traffic database 410 and the cloud platform database 412, the POP recommendation engine 408 may calculate one or more performance metrics for each POP or combination of POPs which may be used to evaluate the performance of each of the POPs or combination of POPs at Step 806. In some embodiments, the performance metric(s) may be used to evaluate the performance of each of the POPs or combination of POPs. The performance metrics may include a round robin RTT time, which may be or include the average RTT value of the median RTT’s weighted average per POP per location. In some embodiments, the performance metrics may include a traffic management optimal RTT time which is the weighted average of each POP within a combination of POPs, with the lowest calculated media RTT per location. In some embodiments, the performance metrics may include a geographical optimal RTT time which is the weighted average of each POP within a combination of POPs, which is geographically closest to the location where the application will be deployed, per distinct location. The POP recommendation engine 408 utilizes dynamic domain name system (DNS) traffic shaping by comparing the round robin RTT, the optimal RTT, and geographical optimal RTT using equations (2) and (3) as described above.

After each POP or combination of POPs is evaluated, the POP recommendation engine 408 may determine whether each POP or combination of POPs has been evaluated to determine the performance metrics at Step 808. If each POP or combination of POPs has been evaluated and performance metrics have been calculated for each POP or combination of POPs, then the method 800 proceeds to Step 810. If not, the method 800 goes back to Step 806. The POP recommendation engine 408 repeats Step 806 until each POP or combination of POPs has been evaluated and performance metrics have been calculated.

After the performance metrics have been calculated for each POP or combination of POPs, the POP recommendation engine 408 may determine an optimal RTT value (e.g., ITM optimal RTT) and generate a ranked recommendation list of POPs or combination of POPs based on comparing the evaluation of each POP or combination of POPs to the optimal RTT value at Step 812. The ranked recommendation list ranks the POP recommendations based on their performance. In some embodiments, the ranked recommendation list may also be based on the cost for each POP or combination of POPs. In some embodiments, the recommendation (e.g., the ranked recommendation list) may be generated as a JSON object. Then the POP recommendation engine 408 returns the generated JSON object to the traffic management portal 406 which is then sent to the traffic management front end 404 where the recommendation may be displayed to the admin 402.

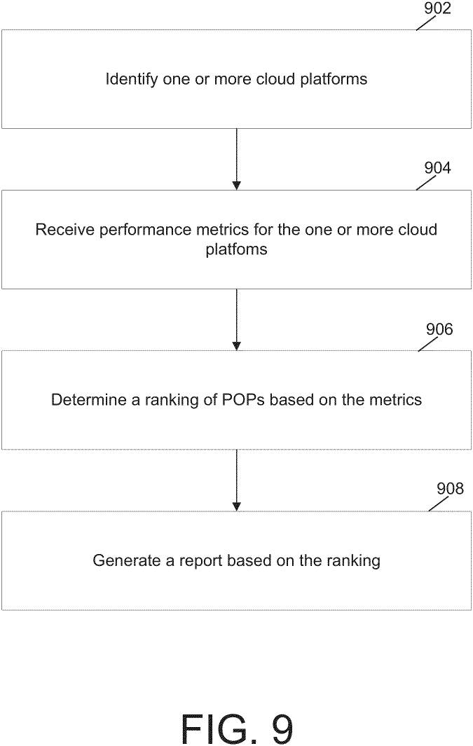

Referring now to FIG. 9, a diagram of a method 900 for generating a report that ranks one or more POPs is shown in accordance with an illustrative embodiment. The components described in FIGS. 1-7, and/or the system 400 detailed above can perform the operations and functionalities of the method 900. The method 900 generates a POP recommendation report based the parameters of the POP recommendation request (e.g., the desired locations, the desired cloud platforms, etc.), the performance of each cloud platform, and the usage traffic data. More details about how the recommendation is generated is outlined below. In brief overview, the POP recommendation system 400 identifies one or more cloud platforms selected from multiple cloud platforms for which to rank one or more points of presence (POP) of multiple POPs provided by each of the one or more cloud platforms (Step 902). The POP recommendation system 400 then receives performance metrics on performance of accessing one or more networks by devices via each of the one or more POPs across each of the one or more cloud platforms (Step 904). The POP recommendation system 400 then determines a ranking of the multiple POPs across the one or more cloud platforms based on the performance metrics (Step 906). The POP recommendation system 400 then generates a report identifying the rankings for at least the one or more POPs of the multiple POPs across the one or more cloud platforms (Step 908).

Referring now to FIG. 9 in more detail, the POP recommendation engine 408 may identify one or more cloud platforms selected from multiple cloud platforms for which to rank one or more points of presence (POP) of multiple POPs provided by each of the one or more cloud platforms at Step 902. The POP recommendation engine 408 may identify the one or more cloud platforms based on the cloud platform parameter provided by POP recommendation request. As mentioned above, the admin 402 may request to include only a single or multiple cloud platform when considering which POPs to use to deploy their application. The admin 402 may communicate these constraints to POP recommendation engine 408 through the POP recommendation request which may be entered through the traffic management front end 404. The constraints may then be used by the POP recommendation engine 408 to identify which cloud platforms and POPs provided by the cloud platforms to evaluate, rank, and include in the generated report.

After the POP recommendation engine 408 identifies the one or more cloud platforms selected from multiple cloud platforms for which to rank one or more points of presence (POP) of multiple POPs provided by each of the one or more cloud platforms, the POP recommendation engine 408 may receive performance metrics on the performance of accessing one or more networks by devices via each of the one or more POPs across each of the one or more cloud platforms at Step 904. The POP recommendation engine 408 may receive the performance metrics from the cloud platform database 412. In some embodiments, the performance metrics may include a round robin RTT time which is the average RTT value of the median RTT’s weighted average per POP per location. In some embodiments, the performance metrics may include a traffic management optimal RTT time which is the weighted average of each POP within a combination of POPs, with the lowest calculated media RTT per location. In some embodiments, the performance metrics may include a geographical optimal RTT time which is the weighted average of each POP within a combination of POPs, which is geographically closest to the location where the application will be deployed, per distinct location. The POP recommendation engine 408 utilizes dynamic domain name system (DNS) traffic shaping by comparing the round robin RTT, the optimal RTT, and geographical optimal RTT using (2) and (3) as described above. In some embodiments, either one, multiple, or all of these performance metrics may be used.

After the POP recommendation engine 408 receives performance metrics, the POP recommendation engine 408 may determine a ranking of the multiple POPs across the one or more cloud platforms based on the performance metrics at Step 906. Other factors, such as the usage distribution data and cost may also be used by the recommendation engine 408 to determine a ranking of the multiple POPs. More specifically, the usage distribution data from the usage traffic database 410 may be combined with the cloud performance metric data from the cloud platform database 412 to determine a ranking of the multiple POPs across one or more cloud platforms. The ranking of multiple POPs may be constrained based on the policies or rules set by the user through their HTTP request. For example, the user may request to constrain the POP evaluation based on constraints related to cost and/or network security or privacy. Therefore, the ranked list may only rank POPs or combination of POPs that fit within the constraints.

After the POP recommendation engine 408 determines the ranking of the multiple POPs across the one or more cloud platforms based on the metrics, the POP recommendation engine 408 may generate a report identifying the rankings for at least the one or more POPs of the multiple POPs across the one or more cloud platforms at Step 908. The generated report may list the one or more POPs of the multiple POPs across the one or more cloud platforms from best performance (most recommended) to worst performance (least recommended). The generated report may list the one or more POPs of the multiple POPs across the one or more cloud platforms from worst performance (lease recommended) to best performance (most recommended). The generated report may be displayed on a user interface (e.g., as shown in user interfaces 500 and 600 above).

### E. Example Embodiments

The following examples pertain to further example embodiments, from which permutations and configurations will be apparent.

Example 1 includes a method. The method includes identifying, by one or more processors, one or more cloud platforms selected from a plurality of cloud platforms for which to rank one or more points of presence (POP) of a plurality of POPs provided by each of the one or more cloud platforms. The method includes receiving, by the one or more processors, metrics on performance of accessing one or more networks by devices via each of the one or more POPs of the plurality of POPs across each of the one or more cloud platforms. The method includes determining, by the one or more processors, a ranking of the plurality of POPs across the one or more cloud platforms based on the metrics. The method includes generating, by the one or more processors, a report identifying the rankings for at least the one or more POPs of the plurality of POPs across the one or more cloud platforms.

Example 2 includes the subject matter of Example 1, further comprising receiving, by the one or more processors, from a computing device, a request for the report, the request including the selection of the one or more cloud platforms from the plurality of cloud platform and transmitting, by the one or more processors, the report to the computing device.

Example 3 includes the subject matter of any of Examples 1 and 2, the request is received at a time instance, and wherein the rankings are determined based on metrics obtained within a duration from the time instance.

Example 4 includes the subject matter of any of Examples 1 through 3, wherein the request identifies one or more geographic regions based on which the report is to be generated.

Example 5 includes the subject matter of any of Examples 1 through 4, wherein the one or more geographic regions correspond to locations in which devices are to access a resource via a respective POP of the plurality of POPs.

Example 6 includes the subject matter of any of Examples 1 through 5, wherein generating the report comprises generating, by the one or more processors, the report for a resource accessible via the one or more networks through at least some of the plurality of POPs and transmitting, by the one or more processors, the report to a computing device corresponding to the resource.

Example 7 includes the subject matter of any of Examples 1 through 6, wherein the metrics comprise at least one of a median round trip time (RTT), a median throughput, or an average availability for the respective POPs of the plurality of POPs.

Example 8 includes the subject matter of any of Examples 1 through 7, further comprising computing a score indicating performance of the respective POPs of the plurality of POPs, wherein the score is computed based on a weighted average round trip time (RTT) for the respective POP with respect to at least one of a lowest RTT of the plurality of POPs, an RTT for a geographically closest POP, or the median RTT of the plurality of POPs.

Example 9 includes the subject matter of any of Examples 1 through 8, wherein the selection of the one or more cloud platforms from the plurality of cloud platforms comprises a selection of each of the plurality of cloud platforms, and wherein the report includes rankings for at least some of the plurality of POPs of the plurality of cloud platforms.

Example 10 includes a system. The system includes one or more processors. The one or more processors are configured to identify one or more cloud platforms selected from a plurality of cloud platforms for which to rank one or more points of presence (POP) of a plurality of POPs provided by each of the one or more cloud platforms. The one or more processors are configured to receive metrics on performance of accessing one or more networks by devices via each of the one or more POPs of the plurality of POPs across each of the one or more cloud platforms. The one or more processors are configured to determine a ranking of the plurality of POPs across the one or more cloud platforms based on the metrics. The one or more processors are configured to generate a report identifying the rankings for at least the one or more POPs of the plurality of POPs across the one or more cloud platforms.

Example 11 includes the subject matter of claim 10, wherein the one or more processors are further configured to receive, from a computing device, a request for the report, the request including the selection of the one or more cloud platforms from the plurality of cloud platforms and transmit the report to the computing device.

Example 12 includes the subject matter of Example 10 and 11, wherein the request is received at a time instance, and wherein the rankings are determined based on metrics obtained within a duration from the time instance.

Example 13 includes the subject matter of any of Examples 10 through 12, wherein the request identifies one or more geographic regions based on which the report is to be generated.

Example 14 includes the subject matter of any of Examples 10 through 13, wherein the one or more geographic regions correspond to locations in which devices are to access a resource via a respective POP of the plurality of POPs.

Example 15 includes the subject matter of any of Examples 11 through 14, wherein the one or more processors are further configured to generate the report for a resource via the one or more networks through at least some of the plurality of POPs and transmit the report to a computing device corresponding to the resource.

Example 16 includes the subject matter of any of Examples 11 through 15, wherein the metrics comprise at least one of a median round trip time (RTT), a median throughput, or an average availability for the respective POPs of the plurality of POPs.

Example 17 includes the subject matter of any of Examples 11 through 16, wherein the one or more processors are further configured to compute a score indicating performance of the respective POPs of the plurality of POPs, wherein the score is computed based on a weighted average round trip time (RTT) for the respective POP with respect to at least one of a lowest RTT of the plurality of POPs, an RTT for a geographically closest POP, or the median RTT of the plurality of POPs.

Example 18 includes the subject matter of any of Examples 11 through 17, wherein the selection of the one or more cloud platforms from the plurality of cloud platforms comprises a selection of each of the plurality of cloud platforms, and wherein the report includes rankings for at least some of the plurality of POPs of the plurality of cloud platforms.

Example 19 includes a non-transitory computer readable medium storing program instructions that, when executed by one or more processors, cause the one or more processors to identify one or more cloud platforms selected from a plurality of cloud platforms for which to rank one or more points of presence (POP) of a plurality of POPs provided by each of the one or more cloud platforms. The computer-readable medium further stores instructions that cause the one or more processors to receive metrics on performance of accessing one or more networks by devices via each of the one or more POPs of the plurality of POPs across each of the one or more cloud platforms. The computer-readable medium further stores instructions that cause the one or more processors to determine a ranking of the plurality of POPs across the one or more cloud platforms based on the metrics. The computer-readable medium further stores instructions that cause the one or more processors to generate a report identifying the rankings for at least the one or more POPs of the plurality of POPs across the one or more cloud platforms.

Example 20 includes the subject matter of claim 19, wherein the metrics comprise at least one of a median round trip time (RTT), a median throughput, or an average availability for the respective POPs of the plurality of POPs, and wherein the instructions further cause the one or more processors to compute a score indicating performance of the respective POPs of the plurality of POPs, wherein the score is computed based on a weighted average round trip time (RTT) for the respective POP with respect to at least one of a lowest RTT of the plurality of POPs, an RTT for a geographically closest POP, or the median RTT of the plurality of POPs.

Various elements, which are described herein in the context of one or more embodiments, may be provided separately or in any suitable subcombination. For example, the processes described herein may be implemented in hardware, software, or a combination thereof. Further, the processes described herein are not limited to the specific embodiments described. For example, the processes described herein are not limited to the specific processing order described herein and, rather, process blocks may be re-ordered, combined, removed, or performed in parallel or in serial, as necessary, to achieve the results set forth herein.

It should be understood that the systems described above may provide multiple ones of any or each of those components and these components may be provided on either a standalone machine or, in some embodiments, on multiple machines in a distributed system. The systems and methods described above may be implemented as a method, apparatus or article of manufacture using programming and/or engineering techniques to produce software, firmware, hardware, or any combination thereof. In addition, the systems and methods described above may be provided as one or more computer-readable programs embodied on or in one or more articles of manufacture. The term “article of manufacture” as used herein is intended to encompass code or logic accessible from and embedded in one or more computer-readable devices, firmware, programmable logic, memory devices (e.g., EEPROMs, ROMs, PROMs, RAMs, SRAMs, etc.), hardware (e.g., integrated circuit chip, Field Programmable Gate Array (FPGA), Application Specific Integrated Circuit (ASIC), etc.), electronic devices, a computer-readable non-volatile storage unit (e.g., CD-ROM, USB Flash memory, hard disk drive, etc.). The article of manufacture may be accessible from a file server providing access to the computer-readable programs via a network transmission line, wireless transmission media, signals propagating through space, radio waves, infrared signals, etc. The article of manufacture may be a flash memory card or a magnetic tape. The article of manufacture includes hardware logic as well as software or programmable code embedded in a computer-readable medium that is executed by a processor. In general, the computer-readable programs may be implemented in any programming language, such as LISP, PERL, C, C++, C#, PROLOG, or in any byte code language such as JAVA. The software programs may be stored on or in one or more articles of manufacture as object code.

While various embodiments of the methods and systems have been described, these embodiments are illustrative and in no way limit the scope of the described methods or systems. Those having skill in the relevant art can effect changes to form and details of the described methods and systems without departing from the broadest scope of the described methods and systems. Thus, the scope of the methods and systems described herein should not be limited by any of the illustrative embodiments and should be defined in accordance with the accompanying claims and their equivalents.

What is claimed is:

1. A method comprising:
identifying, by one or more processors, one or more cloud platforms selected from a plurality of cloud platforms for which to rank one or more points of presence (POP) of a plurality of POPs provided by each of the one or more cloud platforms;
receiving, by the one or more processors, metrics on performance of accessing one or more networks by devices via each of the one or more POPs of the plurality of POPs across each of the one or more cloud platforms;
determining, by the one or more processors, a ranking of the plurality of POPs across the one or more cloud platforms based on the metrics; and
generating, by the one or more processors, a report identifying the rankings for at least the one or more POPs of the plurality of POPs across the one or more cloud platforms.

2. The method of claim 1, further comprising:
receiving, by the one or more processors, from a computing device, a request for the report, the request including the selection of the one or more cloud platforms from the plurality of cloud platforms;
transmitting, by the one or more processors, the report to the computing device.

3. The method of claim 2, wherein the request is received at a time instance, and wherein the rankings are determined based on metrics obtained within a duration from the time instance.

4. The method of claim 2, wherein the request identifies one or more geographic regions based on which the report is to be generated.

5. The method of claim 4, wherein the one or more geographic regions correspond to locations in which devices are to access a resource via a respective POP of the plurality of POPs.

6. The method of claim 1, wherein generating the report comprises:
generating, by the one or more processors, the report for a resource accessible via the one or more networks through at least some of the plurality of POPs; and
transmitting, by the one or more processors, the report to a computing device corresponding to the resource.

7. The method of claim 1, wherein the metrics comprise at least one of a median round trip time (RTT), a median throughput, or an average availability for the respective POPs of the plurality of POPs.

8. The method of claim 7, further comprising computing a score indicating performance of the respective POPs of the plurality of POPs, wherein the score is computed based on a weighted average round trip time (RTT) for the respective POP with respect to at least one of a lowest RTT of the plurality of POPs, an RTT for a geographically closest POP, or the median RTT of the plurality of POPs.

9. The method of claim 1, wherein the selection of the one or more cloud platforms from the plurality of cloud platforms comprises a selection of each of the plurality of cloud platforms, and wherein the report includes rankings for at least some of the plurality of POPs of the plurality of cloud platforms.

10. A system comprising:
one or more processors configured to:
identify one or more cloud platforms selected from a plurality of cloud platforms for which to rank one or more points of presence (POP) of a plurality of POPs provided by each of the one or more cloud platforms;
receive metrics on performance of accessing one or more networks by devices via each of the one or more POPs of the plurality of POPs across each of the one or more cloud platforms;
determine a ranking of the plurality of POPs across the one or more cloud platforms based on the metrics; and
generate a report identifying the rankings for at least the one or more POPs of the plurality of POPs across the one or more cloud platforms.

11. The system of claim 10, wherein the one or more processors are configured to:
receive, from a computing device, a request for the report, the request including the selection of the one or more cloud platforms from the plurality of cloud platforms;
transmit the report to the computing device.

12. The system of claim 11, wherein the request is received at a time instance, and wherein the rankings are determined based on metrics obtained within a duration from the time instance.

13. The system of claim 11, wherein the request identifies one or more geographic regions based on which the report is to be generated.

14. The system of claim 13, wherein the one or more geographic regions correspond to locations in which devices are to access a resource via a respective POP of the plurality of POPs.

15. The system of claim 10, wherein to generate the report, the one or more processors are configured to:
generate the report for a resource via the one or more networks through at least some of the plurality of POPs; and
transmit the report to a computing device corresponding to the resource.

16. The system of claim 10, wherein the metrics comprise at least one of a median round trip time (RTT), a median throughput, or an average availability for the respective POPs of the plurality of POPs.

17. The system of claim 16, wherein the one or more processors are further configured to compute a score indicating performance of the respective POPs of the plurality of POPs, wherein the score is computed based on a weighted average round trip time (RTT) for the respective POP with respect to at least one of a lowest RTT of the plurality of POPs, an RTT for a geographically closest POP, or the median RTT of the plurality of POPs.

18. The system of claim 10, wherein the selection of the one or more cloud platforms from the plurality of cloud platforms comprises a selection of each of the plurality of cloud platforms, and wherein the report includes rankings for at least some of the plurality of POPs of the plurality of cloud platforms.

19. A non-transitory computer readable medium storing instructions that, when executed by one or more processors, cause the one or more processors to:
identify one or more cloud platforms selected from a plurality of cloud platforms for which to rank one or more points of presence (POP) of a plurality of POPs provided by each of the one or more cloud platforms;
receive metrics on performance of accessing one or more networks by devices via each of the one or more POPs of the plurality of POPs across each of the one or more cloud platforms;
determine a ranking of the plurality of POPs across the one or more cloud platforms based on the metrics; and
generate a report identifying the rankings for at least the one or more POPs of the plurality of POPs across the one or more cloud platforms.

20. The non-transitory computer readable medium of claim 19, wherein the metrics comprise at least one of a median round trip time (RTT), a median throughput, or an average availability for the respective POPs of the plurality of POPs, and wherein the instructions further cause the one or more processors to compute a score indicating performance of the respective POPs of the plurality of POPs, wherein the score is computed based on a weighted average round trip time (RTT) for the respective POP with respect to at least one of a lowest RTT of the plurality of POPs, an RTT for a geographically closest POP, or the median RTT of the plurality of POPs.
